(19) United States
(12) Patent Application Publication
(10) Pub. No.: US 2023/0176163 A1
(43) Pub. Date: Jun. 8, 2023

(54) POSITIONING REFERENCE SIGNAL CONFIGURATION AND MANAGEMENT

(71) Applicant: QUALCOMM Incorporated, San Diego, CA (US)

(72) Inventors: Srinivas YERRAMALLI, San Diego, CA (US); Alexandros MANOLAKOS, Escondido, CA (US); Mukesh KUMAR, Hyderabad (IN); Marwen ZORGUI, San Diego, CA (US); Mohammad Tarek FAHIM, San Diego, CA (US)

(21) Appl. No.: 18/007,313

(22) PCT Filed: Sep. 1, 2021
(86) PCT No.: PCT/US2021/048613

§ 371 Date: Jan. 30, 2023

(30) Foreign Application Priority Data
Sep. 22, 2020 (IN) 202011040980

(51) Int. Cl. G01S 5/00; H04L 5/00; G01S 5/02

(52) U.S. Cl. CPC G01S 5/0036; H04L 5/0051; G01S 5/0236; G01S 5/0218

(57) ABSTRACT

A signal measurement assistance method includes: obtaining reference signal angle information comprising first indications indicating a first reference signal and a first expected angle of arrival of the first reference signal; and at least one of: requesting a transmission/reception point (TRP) to transmit, to a user equipment, the first indications; or requesting the TRP to search for the first reference signal based on the first expected angle of arrival.

### CROSS-REFERENCE TO RELATED APPLICATIONS

This application claims the benefit of India Patent Application No. 202011040980, filed Sep. 22, 2020, entitled “RS CONFIGURATION AND MANAGEMENT,” which is assigned to the assignee hereof, and the entire contents of which are hereby incorporated herein by reference for all purposes.

### BACKGROUND

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service, a fourth-generation (4G) service (e.g., Long Term Evolution (LTE) or WiMax), a fifth-generation (5G) service, etc. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Orthogonal Frequency Division Multiple Access (OFDMA), Time Division Multiple Access (TDMA), the Global System for Mobile access (GSM) variation of TDMA, etc.

A fifth generation (5G) mobile standard calls for higher data transfer speeds, greater numbers of connections, and better coverage, among other improvements. The 5G standard, according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Consequently, the spectral efficiency of 5G mobile communications should be significantly enhanced compared to the current 4G standard. Furthermore, signaling efficiencies should be enhanced and latency should be substantially reduced compared to current standards.

### SUMMARY

An example network entity includes: an interface; a memory; and a processor communicatively coupled to the interface and the memory and configured to: obtain reference signal angle information comprising first indications indicating a first reference signal and a first expected angle of arrival of the first reference signal; and at least one of: request a transmission/reception point (TRP) to transmit, to a user equipment, the first indications; or request the TRP to search for the first reference signal based on the first expected angle of arrival.

An example signal measurement assistance method includes: obtaining reference signal angle information comprising first indications indicating a first reference signal and a first expected angle of arrival of the first reference signal; and at least one of: requesting a transmission/reception point (TRP) to transmit, to a user equipment, the first indications; or requesting the TRP to search for the first reference signal based on the first expected angle of arrival.

An example user equipment includes: a transceiver; a memory; and a processor communicatively coupled to the transceiver and the memory and configured to: transmit, via the transceiver to a network entity, an angle use capability message indicating a capability of the UE to use signal angle information to measure signals; receive, via the transceiver from the network entity, a reference signal indication indicating a reference signal and at least one reference signal angle search window corresponding to the reference signal; and search for the reference signal based on the at least one reference signal angle search window.

An example method for measuring a reference signal at a user equipment includes: transmitting, from the user equipment to a network entity, an angle use capability message indicating a capability of the user equipment to use signal angle information to measure signals; receiving, at the user equipment from the network entity, a reference signal indication indicating the reference signal and at least one reference signal angle search window corresponding to the reference signal; searching, at the user equipment, for the reference signal based on the at least one reference signal angle search window; and measuring the reference signal at the user equipment.

### BRIEF DESCRIPTION OF THE DRAWINGS

FIG. 1 is a simplified diagram of an example wireless communications system.

FIG. 2 is a block diagram of components of an example user equipment shown in FIG. 1.

FIG. 3 is a block diagram of components of an example transmission/reception point.

FIG. 4 is a block diagram of components of an example server, various embodiments of which are shown in FIG. 1.

FIG. 5 is a block diagram of an example user equipment.

FIG. 6 is a block diagram of an example network entity.

FIG. 7A is a perspective view of a signal received at an angle of arrival from a base station.

FIG. 7B is a simplified diagram of a signal received at a line-of-sight angle of arrival from a base station and at a reflected angle of arrival from the base station.

FIG. 8 is a simplified diagram of examples of receive-signal paths of the user equipment shown in FIG. 5.

FIG. 9 is a processing and signal flow for determining position information.

FIG. 10 is a simplified example of an angle capacity message shown in FIG. 9.

FIG. 11 is a simplified example of a table of sets of reference signal angle information.

FIG. 12 is a simplified example of a reference signal angle information message shown in FIG. 9.

FIG. 13 is a block flow diagram of a signal measurement assistance method.

FIG. 14 is a block flow diagram of a method for measuring a reference signal.

### DETAILED DESCRIPTION

Techniques are discussed herein for facilitating measurement of signals such as reference signals. For example, a user equipment may indicate one or more abilities of the user equipment to use angle assistance information to search for, receive, and measure (reference) signals. The abilities may be indicated for respective reference signals and/or one or more respective characteristics of reference signals (e.g., frequency band, frequency band combination). A network entity may request a transmission/reception point to send angle assistance information to the user equipment to help reduce an angular search window used by the user equipment to receive the (reference) signal(s). The user equipment may provide feedback to the network entity to help improve the angle assistance information. Other examples, however, may be implemented.

Items and/or techniques described herein may provide one or more of the following capabilities, as well as other capabilities not mentioned. Latency of position information determination may be reduced, e.g., by reducing time to find a signal to be measured. Position information determination accuracy may be improved.

Computational complexity may be reduced, e.g., by reducing processing to find a received signal. Other capabilities may be provided and not every implementation according to the disclosure must provide any, let alone all, of the capabilities discussed.

Obtaining the locations of mobile devices that are accessing a wireless network may be useful for many applications including, for example, emergency calls, personal navigation, consumer asset tracking, locating a friend or family member, etc. Existing positioning methods include methods based on measuring radio signals transmitted from a variety of devices or entities including satellite vehicles (SVs) and terrestrial radio sources in a wireless network such as base stations and access points. It is expected that standardization for the 5G wireless networks will include support for various positioning methods, which may utilize reference signals transmitted by base stations in a manner similar to which LTE wireless networks currently utilize Positioning Reference Signals (PRS) and/or Cell-specific Reference Signals (CRS) for position determination.

The description may refer to sequences of actions to be performed, for example, by elements of a computing device. Various actions described herein can be performed by specific circuits (e.g., an application specific integrated circuit (ASIC)), by program instructions being executed by one or more processors, or by a combination of both. Sequences of actions described herein may be embodied within a non-transitory computer-readable medium having stored thereon a corresponding set of computer instructions that upon execution would cause an associated processor to perform the functionality described herein. Thus, the various aspects described herein may be embodied in a number of different forms, all of which are within the scope of the disclosure, including claimed subject matter.

As used herein, the terms “user equipment” (UE) and “base station” are not specific to or otherwise limited to any particular Radio Access Technology (RAT), unless otherwise noted. In general, such UEs may be any wireless communication device (e.g., a mobile phone, router, tablet computer, laptop computer, consumer asset tracking device, Internet of Things (IoT) device, etc.) used by a user to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” a “mobile device,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, WiFi networks (e.g., based on IEEE 802.11, etc.) and so on.

A base station may operate according to one of several RATs in communication with UEs depending on the network in which it is deployed. Examples of a base station include an Access Point (AP), a Network Node, a NodeB, an evolved NodeB (eNB), or a general Node B (gNodeB, gNB). In addition, in some systems a base station may provide purely edge node signaling functions while in other systems it may provide additional control and/or network management functions.

UEs may be embodied by any of a number of types of devices including but not limited to printed circuit (PC) cards, compact flash devices, external or internal modems, wireless or wireline phones, smartphones, tablets, consumer asset tracking devices, asset tags, and so on. A communication link through which UEs can send signals to a RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

As used herein, the term “cell” or “sector” may correspond to one of a plurality of cells of a base station, or to the base station itself, depending on the context. The term “cell” may refer to a logical communication entity used for communication with a base station (for example, over a carrier), and may be associated with an identifier for distinguishing neighboring cells (for example, a physical cell identifier (PCID), a virtual cell identifier (VCID)) operating via the same or a different carrier. In some examples, a carrier may support multiple cells, and different cells may be configured according to different protocol types (for example, machine-type communication (MTC), narrowband Internet-of-Things (NB-IoT), enhanced mobile broadband (eMBB), or others) that may provide access for different types of devices. In some examples, the term “cell” may refer to a portion of a geographic coverage area (for example, a sector) over which the logical entity operates.

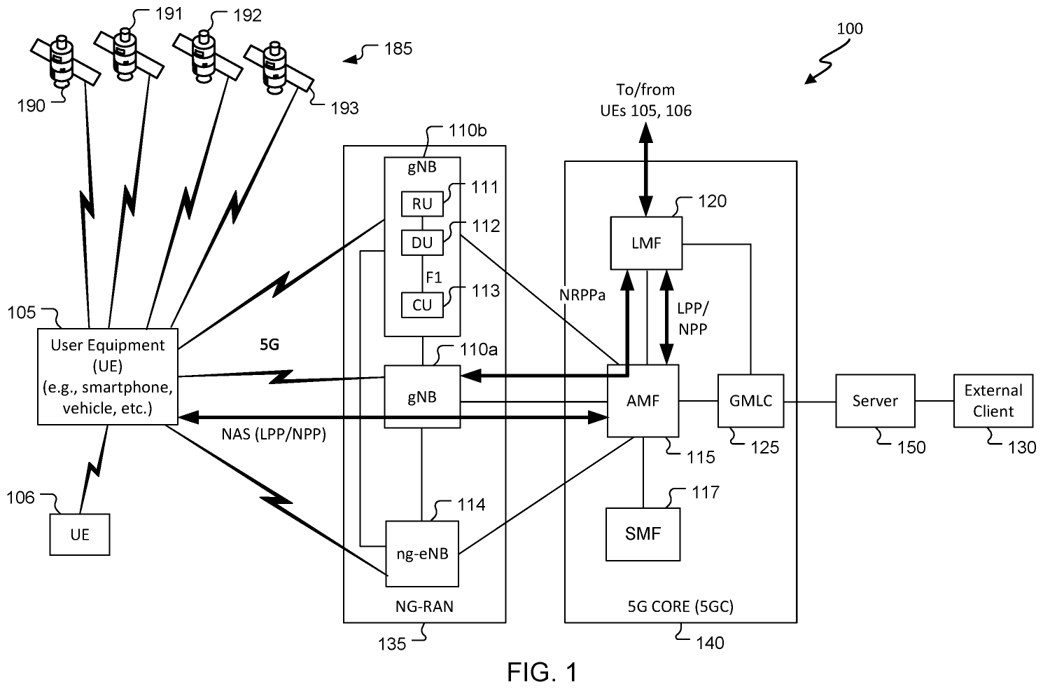

Referring to FIG. 1, an example of a communication system 100 includes a UE 105, a UE 106, a Radio Access Network (RAN), here a Fifth Generation (5G) Next Generation (NG) RAN (NG-RAN) 135, a 5G Core Network (5GC) 140, and a server 150. The UE 105 and/or the UE 106 may be, e.g., an IoT device, a location tracker device, a cellular telephone, a vehicle (e.g., a car, a truck, a bus, a boat, etc.), or other device. A 5G network may also be referred to as a New Radio (NR) network; NG-RAN 135 may be referred to as a 5G RAN or as an NR RAN; and 5GC 140 may be referred to as an NG Core network (NGC). Standardization of an NG-RAN and 5GC is ongoing in the 3rd Generation Partnership Project (3GPP). Accordingly, the NG-RAN 135 and the 5GC 140 may conform to current or future standards for 5G support from 3GPP. The NG-RAN 135 may be another type of RAN, e.g., a 3G RAN, a 4G Long Term Evolution (LTE) RAN, etc. The UE 106 may be configured and coupled similarly to the UE 105 to send and/or receive signals to/from similar other entities in the system 100, but such signaling is not indicated in FIG. 1 for the sake of simplicity of the figure. Similarly, the discussion focuses on the UE 105 for the sake of simplicity. The communication system 100 may utilize information from a constellation 185 of satellite vehicles (SVs) 190, 191, 192, 193 for a Satellite Positioning System (SPS) (e.g., a Global Navigation Satellite System (GNSS)) like the Global Positioning System (GPS), the Global Navigation Satellite System (GLONASS), Galileo, or Beidou or some other local or regional SPS such as the Indian Regional Navigational Satellite System (IRNSS), the European Geostationary Navigation Overlay Service (EGNOS), or the Wide Area Augmentation System (WAAS). Additional components of the communication system 100 are described below. The communication system 100 may include additional or alternative components.

As shown in FIG. 1, the NG-RAN 135 includes NR nodeBs (gNBs) 110a, 110b, and a next generation eNodeB (ng-eNB) 114, and the 5GC 140 includes an Access and Mobility Management Function (AMF) 115, a Session Management Function (SMF) 117, a Location Management Function (LMF) 120, and a Gateway Mobile Location Center (GMLC) 125. The gNBs 110a, 110b and the ng-eNB 114 are communicatively coupled to each other, are each configured to bi-directionally wirelessly communicate with the UE 105, and are each communicatively coupled to, and configured to bi-directionally communicate with, the AMF 115. The gNBs 110a, 110b, and the ng-eNB 114 may be referred to as base stations (BSs). The AMF 115, the SMF 117, the LMF 120, and the GMLC 125 are communicatively coupled to each other, and the GMLC is communicatively coupled to an external client 130. The SMF 117 may serve as an initial contact point of a Service Control Function (SCF) (not shown) to create, control, and delete media sessions. Base stations such as the gNBs 110a, 110b and/or the ng-eNB 114 may be a macro cell (e.g., a high-power cellular base station), or a small cell (e.g., a low-power cellular base station), or an access point (e.g., a short-range base station configured to communicate with short-range technology such as WiFi, WiFi-Direct (WiFi-D), Bluetooth®, Bluetooth®-low energy (BLE), Zigbee, etc. One or more BSs, e.g., one or more of the gNBs 110a, 110b and/or the ng-eNB 114 may be configured to communicate with the UE 105 via multiple carriers. Each of the gNBs 110a, 110b and the ng-eNB 114 may provide communication coverage for a respective geographic region, e.g. a cell. Each cell may be partitioned into multiple sectors as a function of the base station antennas.

FIG. 1 provides a generalized illustration of various components, any or all of which may be utilized as appropriate, and each of which may be duplicated or omitted as necessary. Specifically, although one UE 105 is illustrated, many UEs (e.g., hundreds, thousands, millions, etc.) may be utilized in the communication system 100. Similarly, the communication system 100 may include a larger (or smaller) number of SVs (i.e., more or fewer than the four SVs 190-193 shown), gNBs 110a, 110b, ng-eNBs 114, AMFs 115, external clients 130, and/or other components. The illustrated connections that connect the various components in the communication system 100 include data and signaling connections which may include additional (intermediary) components, direct or indirect physical and/or wireless connections, and/or additional networks. Furthermore, components may be rearranged, combined, separated, substituted, and/or omitted, depending on desired functionality.

While FIG. 1 illustrates a 5G-based network, similar network implementations and configurations may be used for other communication technologies, such as 3G, Long Term Evolution (LTE), etc. Implementations described herein (be they for 5G technology and/or for one or more other communication technologies and/or protocols) may be used to transmit (or broadcast) directional synchronization signals, receive and measure directional signals at UEs (e.g., the UE 105) and/or provide location assistance to the UE 105 (via the GMLC 125 or other location server) and/or compute a location for the UE 105 at a location-capable device such as the UE 105, the gNB 110a, 110b, or the LMF 120 based on measurement quantities received at the UE 105 for such directionally-transmitted signals. The gateway mobile location center (GMLC) 125, the location management function (LMF) 120, the access and mobility management function (AMF) 115, the SMF 117, the ng-eNB (eNodeB) 114 and the gNBs (gNodeBs) 110a, 110b are examples and may, in various embodiments, be replaced by or include various other location server functionality and/or base station functionality respectively.

The system 100 is capable of wireless communication in that components of the system 100 can communicate with one another (at least some times using wireless connections) directly or indirectly, e.g., via the gNBs 110a, 110b, the ng-eNB 114, and/or the 5GC 140 (and/or one or more other devices not shown, such as one or more other base transceiver stations). For indirect communications, the communications may be altered during transmission from one entity to another, e.g., to alter header information of data packets, to change format, etc. The UE 105 may include multiple UEs and may be a mobile wireless communication device, but may communicate wirelessly and via wired connections. The UE 105 may be any of a variety of devices, e.g., a smartphone, a tablet computer, a vehicle-based device, etc., but these are examples as the UE 105 is not required to be any of these configurations, and other configurations of UEs may be used. Other UEs may include wearable devices (e.g., smart watches, smart jewelry, smart glasses or headsets, etc.). Still other UEs may be used, whether currently existing or developed in the future. Further, other wireless devices (whether mobile or not) may be implemented within the system 100 and may communicate with each other and/or with the UE 105, the gNBs 110a, 110b, the ng-eNB 114, the 5GC 140, and/or the external client 130. For example, such other devices may include internet of thing (IoT) devices, medical devices, home entertainment and/or automation devices, etc. The 5GC 140 may communicate with the external client 130 (e.g., a computer system), e.g., to allow the external client 130 to request and/or receive location information regarding the UE 105 (e.g., via the GMLC 125).

The UE 105 or other devices may be configured to communicate in various networks and/or for various purposes and/or using various technologies (e.g., 5G, Wi-Fi communication, multiple frequencies of Wi-Fi communication, satellite positioning, one or more types of communications (e.g., GSM (Global System for Mobiles), CDMA (Code Division Multiple Access), LTE (Long-Term Evolution), V2X (Vehicle-to-Everything, e.g., V2P (Vehicle-to-Pedestrian), V2I (Vehicle-to-Infrastructure), V2V (Vehicle-to-Vehicle), etc.), IEEE 802.11p, etc.). V2X communications may be cellular (Cellular-V2X (C-V2X)) and/or WiFi (e.g., DSRC (Dedicated Short-Range Connection)). The system 100 may support operation on multiple carriers (waveform signals of different frequencies). Multi-carrier transmitters can transmit modulated signals simultaneously on the multiple carriers. Each modulated signal may be a Code Division Multiple Access (CDMA) signal, a Time Division Multiple Access (TDMA) signal, an Orthogonal Frequency Division Multiple Access (OFDMA) signal, a Single-Carrier Frequency Division Multiple Access (SC-FDMA) signal, etc. Each modulated signal may be sent on a different carrier and may carry pilot, overhead information, data, etc. The UEs 105, 106 may communicate with each other through UE-to-UE sidelink (SL) communications by transmitting over one or more sidelink channels such as a physical sidelink synchronization channel (PSSCH), a physical sidelink broadcast channel (PSBCH), or a physical sidelink control channel (PSCCH).

The UE 105 may comprise and/or may be referred to as a device, a mobile device, a wireless device, a mobile terminal, a terminal, a mobile station (MS), a Secure User Plane Location (SUPL) Enabled Terminal (SET), or by some other name. Moreover, the UE 105 may correspond to a cellphone, smartphone, laptop, tablet, PDA, consumer asset tracking device, navigation device, Internet of Things (IoT) device, health monitors, security systems, smart city sensors, smart meters, wearable trackers, or some other portable or moveable device. Typically, though not necessarily, the UE 105 may support wireless communication using one or more Radio Access Technologies (RATs) such as Global System for Mobile communication (GSM), Code Division Multiple Access (CDMA), Wideband CDMA (WCDMA), LTE, High Rate Packet Data (HRPD), IEEE 802.11 WiFi (also referred to as Wi-Fi), Bluetooth® (BT), Worldwide Interoperability for Microwave Access (WiMAX), 5G new radio (NR) (e.g., using the NG-RAN 135 and the 5GC 140), etc. The UE 105 may support wireless communication using a Wireless Local Area Network (WLAN) which may connect to other networks (e.g., the Internet) using a Digital Subscriber Line (DSL) or packet cable, for example. The use of one or more of these RATs may allow the UE 105 to communicate with the external client 130 (e.g., via elements of the 5GC 140 not shown in FIG. 1, or possibly via the GMLC 125) and/or allow the external client 130 to receive location information regarding the UE 105 (e.g., via the GMLC 125).

The UE 105 may include a single entity or may include multiple entities such as in a personal area network where a user may employ audio, video and/or data I/O (input/output) devices and/or body sensors and a separate wireline or wireless modem. An estimate of a location of the UE 105 may be referred to as a location, location estimate, location fix, fix, position, position estimate, or position fix, and may be geographic, thus providing location coordinates for the UE 105 (e.g., latitude and longitude) which may or may not include an altitude component (e.g., height above sea level, height above or depth below ground level, floor level, or basement level). Alternatively, a location of the UE 105 may be expressed as a civic location (e.g., as a postal address or the designation of some point or small area in a building such as a particular room or floor). A location of the UE 105 may be expressed as an area or volume (defined either geographically or in civic form) within which the UE 105 is expected to be located with some probability or confidence level (e.g., 67%, 95%, etc.). A location of the UE 105 may be expressed as a relative location comprising, for example, a distance and direction from a known location. The relative location may be expressed as relative coordinates (e.g., X, Y (and Z) coordinates) defined relative to some origin at a known location which may be defined, e.g., geographically, in civic terms, or by reference to a point, area, or volume, e.g., indicated on a map, floor plan, or building plan. In the description contained herein, the use of the term location may comprise any of these variants unless indicated otherwise. When computing the location of a UE, it is common to solve for local x, y, and possibly z coordinates and then, if desired, convert the local coordinates into absolute coordinates (e.g., for latitude, longitude, and altitude above or below mean sea level).

The UE 105 may be configured to communicate with other entities using one or more of a variety of technologies. The UE 105 may be configured to connect indirectly to one or more communication networks via one or more device-to-device (D2D) peer-to-peer (P2P) links. The D2D P2P links may be supported with any appropriate D2D radio access technology (RAT), such as LTE Direct (LTE-D), WiFi Direct (WiFi-D), Bluetooth®, and so on. One or more of a group of UEs utilizing D2D communications may be within a geographic coverage area of a Transmission/Reception Point (TRP) such as one or more of the gNBs 110a, 110b, and/or the ng-eNB 114. Other UEs in such a group may be outside such geographic coverage areas, or may be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP. One or more of a group of UEs utilizing D2D communications may be within a geographic coverage area of a TRP. Other UEs in such a group may be outside such geographic coverage areas, or be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP.

Base stations (BSs) in the NG-RAN 135 shown in FIG. 1 include NR Node Bs, referred to as the gNBs 110a and 110b. Pairs of the gNBs 110a, 110b in the NG-RAN 135 may be connected to one another via one or more other gNBs. Access to the 5G network is provided to the UE 105 via wireless communication between the UE 105 and one or more of the gNBs 110a, 110b, which may provide wireless communications access to the 5GC 140 on behalf of the UE 105 using 5G. In FIG. 1, the serving gNB for the UE 105 is assumed to be the gNB 110a, although another gNB (e.g. the gNB 110b) may act as a serving gNB if the UE 105 moves to another location or may act as a secondary gNB to provide additional throughput and bandwidth to the UE 105.

Base stations (BSs) in the NG-RAN 135 shown in FIG. 1 may include the ng-eNB 114, also referred to as a next generation evolved Node B. The ng-eNB 114 may be connected to one or more of the gNBs 110a, 110b in the NG-RAN 135, possibly via one or more other gNBs and/or one or more other ng-eNBs. The ng-eNB 114 may provide LTE wireless access and/or evolved LTE (eLTE) wireless access to the UE 105. One or more of the gNBs 110a, 110b and/or the ng-eNB 114 may be configured to function as positioning-only beacons which may transmit signals to assist with determining the position of the UE 105 but may not receive signals from the UE 105 or from other UEs.

The gNBs 110a, 110b and/or the ng-eNB 114 may each comprise one or more TRPs. For example, each sector within a cell of a BS may comprise a TRP, although multiple TRPs may share one or more components (e.g., share a processor but have separate antennas). The system 100 may include macro TRPs exclusively or the system 100 may have TRPs of different types, e.g., macro, pico, and/or femto TRPs, etc. A macro TRP may cover a relatively large geographic area (e.g., several kilometers in radius) and may allow unrestricted access by terminals with service subscription. A pico TRP may cover a relatively small geographic area (e.g., a pico cell) and may allow unrestricted access by terminals with service subscription. A femto or home TRP may cover a relatively small geographic area (e.g., a femto cell) and may allow restricted access by terminals having association with the femto cell (e.g., terminals for users in a home).

Each of the gNBs 110a, 110b and/or the ng-eNB 114 may include a radio unit (RU), a distributed unit (DU), and a central unit (CU). For example, the gNB 110a includes an RU 111, a DU 112, and a CU 113. The RU 111, DU 112, and CU 113 divide functionality of the gNB 110a. While the gNB 110a is shown with a single RU, a single DU, and a single CU, a gNB may include one or more RUs, one or more DUs, and/or one or more CUs. An interface between the CU 113 and the DU 112 is referred to as an F1 interface. The RU 111 is configured to perform digital front end (DFE) functions (e.g., analog-to-digital conversion, filtering, power amplification, transmission/reception) and digital beamforming, and includes a portion of the physical (PHY) layer. The RU 111 may perform the DFE using massive multiple input/multiple output (MIMO) and may be integrated with one or more antennas of the gNB 110a. The DU 112 hosts the Radio Link Control (RLC), Medium Access Control (MAC), and physical layers of the gNB 110a. One DU can support one or more cells, and each cell is supported by a single DU. The operation of the DU 112 is controlled by the CU 113. The CU 113 is configured to perform functions for transferring user data, mobility control, radio access network sharing, positioning, session management, etc. although some functions are allocated exclusively to the DU 112. The CU 113 hosts the Radio Resource Control (RRC), Service Data Adaptation Protocol (SDAP), and Packet Data Convergence Protocol (PDCP) protocols of the gNB 110a. The UE 105 may communicate with the CU 113 via RRC, SDAP, and PDCP layers, with the DU 112 via the RLC, MAC, and PHY layers, and with the RU 111 via the PHY layer.

As noted, while FIG. 1 depicts nodes configured to communicate according to 5G communication protocols, nodes configured to communicate according to other communication protocols, such as, for example, an LTE protocol or IEEE 802.11x protocol, may be used. For example, in an Evolved Packet System (EPS) providing LTE wireless access to the UE 105, a RAN may comprise an Evolved Universal Mobile Telecommunications System (UMTS) Terrestrial Radio Access Network (E-UTRAN) which may comprise base stations comprising evolved Node Bs (eNBs). A core network for EPS may comprise an Evolved Packet Core (EPC). An EPS may comprise an E-UTRAN plus EPC, where the E-UTRAN corresponds to the NG-RAN 135 and the EPC corresponds to the 5GC 140 in FIG. 1.

The gNBs 110a, 110b and the ng-eNB 114 may communicate with the AMF 115, which, for positioning functionality, communicates with the LMF 120. The AMF 115 may support mobility of the UE 105, including cell change and handover and may participate in supporting a signaling connection to the UE 105 and possibly data and voice bearers for the UE 105. The LMF 120 may communicate directly with the UE 105, e.g., through wireless communications, or directly with the gNBs 110a, 110b and/or the ng-eNB 114. The LMF 120 may support positioning of the UE 105 when the UE 105 accesses the NG-RAN 135 and may support position procedures/methods such as Assisted GNSS (A-GNSS), Observed Time Difference of Arrival (OTDOA) (e.g., Downlink (DL) OTDOA or Uplink (UL) OTDOA), Round Trip Time (RTT), Multi-Cell RTT, Real Time Kinematic (RTK), Precise Point Positioning (PPP), Differential GNSS (DGNSS), Enhanced Cell ID (E-CID), angle of arrival (AoA), angle of departure (AoD), and/or other position methods. The LMF 120 may process location services requests for the UE 105, e.g., received from the AMF 115 or from the GMLC 125. The LMF 120 may be connected to the AMF 115 and/or to the GMLC 125. The LMF 120 may be referred to by other names such as a Location Manager (LM), Location Function (LF), commercial LMF (CLMF), or value added LMF (VLMF). A node/system that implements the LMF 120 may additionally or alternatively implement other types of location-support modules, such as an Enhanced Serving Mobile Location Center (E-SMLC) or a Secure User Plane Location (SUPL) Location Platform (SLP). At least part of the positioning functionality (including derivation of the location of the UE 105) may be performed at the UE 105 (e.g., using signal measurements obtained by the UE 105 for signals transmitted by wireless nodes such as the gNBs 110a, 110b and/or the ng-eNB 114, and/or assistance data provided to the UE 105, e.g. by the LMF 120). The AMF 115 may serve as a control node that processes signaling between the UE 105 and the 5GC 140, and may provide QoS (Quality of Service) flow and session management. The AMF 115 may support mobility of the UE 105 including cell change and handover and may participate in supporting signaling connection to the UE 105.

The server 150, e.g., a cloud server, is configured to obtain and provide location estimates of the UE 105 to the external client 130. The server 150 may, for example, be configured to run a microservice/service that obtains the location estimate of the UE 105. The server 150 may, for example, pull the location estimate from (e.g., by sending a location request to) the UE 105, one or more of the gNBs 110a, 110b (e.g., via the RU 111, the DU 112, and the CU 113) and/or the ng-eNB 114, and/or the LMF 120. As another example, the UE 105, one or more of the gNBs 110a, 110b (e.g., via the RU 111, the DU 112, and the CU 113), and/or the LMF 120 may push the location estimate of the UE 105 to the server 150.

The GMLC 125 may support a location request for the UE 105 received from the external client 130 via the server 150 and may forward such a location request to the AMF 115 for forwarding by the AMF 115 to the LMF 120 or may forward the location request directly to the LMF 120. A location response from the LMF 120 (e.g., containing a location estimate for the UE 105) may be returned to the GMLC 125 either directly or via the AMF 115 and the GMLC 125 may then return the location response (e.g., containing the location estimate) to the external client 130 via the server 150. The GMLC 125 is shown connected to both the AMF 115 and LMF 120, though may not be connected to the AMF 115 or the LMF 120 in some implementations.

As further illustrated in FIG. 1, the LMF 120 may communicate with the gNBs 110a, 110b and/or the ng-eNB 114 using a New Radio Position Protocol A (which may be referred to as NPPa or NRPPa), which may be defined in 3GPP Technical Specification (TS) 38.455. NRPPa may be the same as, similar to, or an extension of the LTE Positioning Protocol A (LPPa) defined in 3GPP TS 36.455, with NRPPa messages being transferred between the gNB 110a (or the gNB 110b) and the LMF 120, and/or between the ng-eNB 114 and the LMF 120, via the AMF 115. As further illustrated in FIG. 1, the LMF 120 and the UE 105 may communicate using an LTE Positioning Protocol (LPP), which may be defined in 3GPP TS 36.355. The LMF 120 and the UE 105 may also or instead communicate using a New Radio Positioning Protocol (which may be referred to as NPP or NRPP), which may be the same as, similar to, or an extension of LPP. Here, LPP and/or NPP messages may be transferred between the UE 105 and the LMF 120 via the AMF 115 and the serving gNB 110a, 110b or the serving ng-eNB 114 for the UE 105. For example, LPP and/or NPP messages may be transferred between the LMF 120 and the AMF 115 using a 5G Location Services Application Protocol (LCS AP) and may be transferred between the AMF 115 and the UE 105 using a 5G Non-Access Stratum (NAS) protocol. The LPP and/or NPP protocol may be used to support positioning of the UE 105 using UE-assisted and/or UE-based position methods such as A-GNSS, RTK, OTDOA and/or E-CID. The NRPPa protocol may be used to support positioning of the UE 105 using network-based position methods such as E-CID (e.g., when used with measurements obtained by the gNB 110a, 110b or the ng-eNB 114) and/or may be used by the LMF 120 to obtain location related information from the gNBs 110a, 110b and/or the ng-eNB 114, such as parameters defining directional SS transmissions from the gNBs 110a, 110b, and/or the ng-eNB 114. The LMF 120 may be co-located or integrated with a gNB or a TRP, or may be disposed remote from the gNB and/or the TRP and configured to communicate directly or indirectly with the gNB and/or the TRP.

With a UE-assisted position method, the UE 105 may obtain location measurements and send the measurements to a location server (e.g., the LMF 120) for computation of a location estimate for the UE 105. For example, the location measurements may include one or more of a Received Signal Strength Indication (RSSI), Round Trip signal propagation Time (RTT), Reference Signal Time Difference (RSTD), Reference Signal Received Power (RSRP) and/or Reference Signal Received Quality (RSRQ) for the gNBs 110a, 110b, the ng-eNB 114, and/or a WLAN AP. The location measurements may also or instead include measurements of GNSS pseudorange, code phase, and/or carrier phase for the SVs 190-193.

With a UE-based position method, the UE 105 may obtain location measurements (e.g., which may be the same as or similar to location measurements for a UE-assisted position method) and may compute a location of the UE 105 (e.g., with the help of assistance data received from a location server such as the LMF 120 or broadcast by the gNBs 110a, 110b, the ng-eNB 114, or other base stations or APs).

With a network-based position method, one or more base stations (e.g., the gNBs 110a, 110b, and/or the ng-eNB 114) or APs may obtain location measurements (e.g., measurements of RSSI, RTT, RSRP, RSRQ or Time of Arrival (ToA) for signals transmitted by the UE 105) and/or may receive measurements obtained by the UE 105. The one or more base stations or APs may send the measurements to a location server (e.g., the LMF 120) for computation of a location estimate for the UE 105.

Information provided by the gNBs 110a, 110b, and/or the ng-eNB 114 to the LMF 120 using NRPPa may include timing and configuration information for directional SS transmissions and location coordinates. The LMF 120 may provide some or all of this information to the UE 105 as assistance data in an LPP and/or NPP message via the NG-RAN 135 and the 5GC 140.

An LPP or NPP message sent from the LMF 120 to the UE 105 may instruct the UE 105 to do any of a variety of things depending on desired functionality. For example, the LPP or NPP message could contain an instruction for the UE 105 to obtain measurements for GNSS (or A-GNSS), WLAN, E-CID, and/or OTDOA (or some other position method). In the case of E-CID, the LPP or NPP message may instruct the UE 105 to obtain one or more measurement quantities (e.g., beam ID, beam width, mean angle, RSRP, RSRQ measurements) of directional signals transmitted within particular cells supported by one or more of the gNBs 110a, 110b, and/or the ng-eNB 114 (or supported by some other type of base station such as an eNB or WiFi AP). The UE 105 may send the measurement quantities back to the LMF 120 in an LPP or NPP message (e.g., inside a 5G NAS message) via the serving gNB 110a (or the serving ng-eNB 114) and the AMF 115.

As noted, while the communication system 100 is described in relation to 5G technology, the communication system 100 may be implemented to support other communication technologies, such as GSM, WCDMA, LTE, etc., that are used for supporting and interacting with mobile devices such as the UE 105 (e.g., to implement voice, data, positioning, and other functionalities). In some such embodiments, the 5GC 140 may be configured to control different air interfaces. For example, the 5GC 140 may be connected to a WLAN using a Non-3GPP InterWorking Function (N3IWF, not shown FIG. 1) in the 5GC 140. For example, the WLAN may support IEEE 802.11 WiFi access for the UE 105 and may comprise one or more WiFi APs. Here, the N3IWF may connect to the WLAN and to other elements in the 5GC 140 such as the AMF 115. In some embodiments, both the NG-RAN 135 and the 5GC 140 may be replaced by one or more other RANs and one or more other core networks. For example, in an EPS, the NG-RAN 135 may be replaced by an E-UTRAN containing eNBs and the 5GC 140 may be replaced by an EPC containing a Mobility Management Entity (MME) in place of the AMF 115, an E-SMLC in place of the LMF 120, and a GMLC that may be similar to the GMLC 125. In such an EPS, the E-SMLC may use LPPa in place of NRPPa to send and receive location information to and from the eNBs in the E-U IRAN and may use LPP to support positioning of the UE 105. In these other embodiments, positioning of the UE 105 using directional PRSs may be supported in an analogous manner to that described herein for a 5G network with the difference that functions and procedures described herein for the gNBs 110a, 110b, the ng-eNB 114, the AMF 115, and the LMF 120 may, in some cases, apply instead to other network elements such eNBs, WiFi APs, an MME, and an E-SMLC.

As noted, in some embodiments, positioning functionality may be implemented, at least in part, using the directional SS beams, sent by base stations (such as the gNBs 110a, 110b, and/or the ng-eNB 114) that are within range of the UE whose position is to be determined (e.g., the UE 105 of FIG. 1). The UE may, in some instances, use the directional SS beams from a plurality of base stations (such as the gNBs 110a, 110b, the ng-eNB 114, etc.) to compute the UE's position.

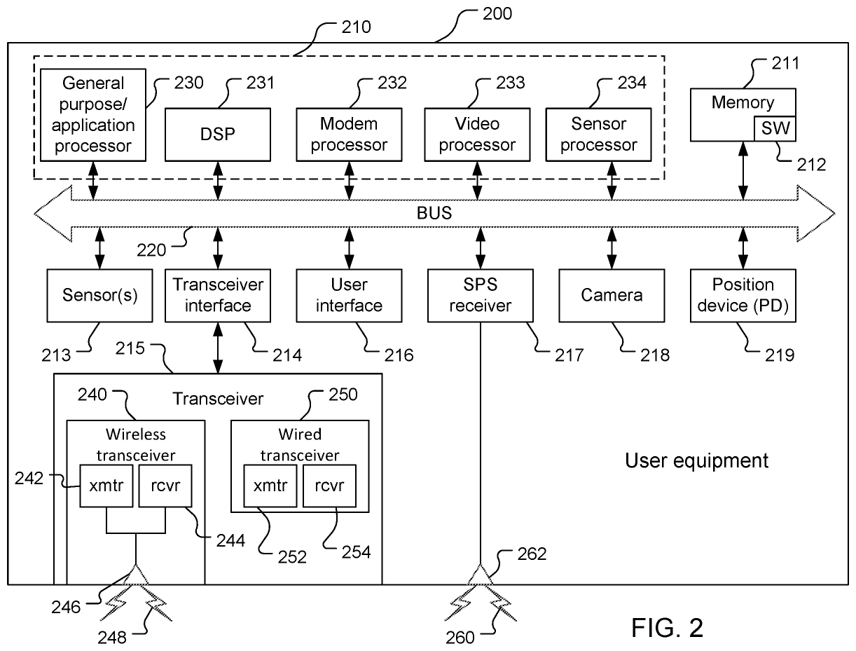

Referring also to FIG. 2, a UE 200 is an example of one of the UEs 105, 106 and comprises a computing platform including a processor 210, memory 211 including software (SW) 212, one or more sensors 213, a transceiver interface 214 for a transceiver 215 (that includes a wireless transceiver 240 and a wired transceiver 250), a user interface 216, a Satellite Positioning System (SPS) receiver 217, a camera 218, and a position device (PD) 219. The processor 210, the memory 211, the sensor(s) 213, the transceiver interface 214, the user interface 216, the SPS receiver 217, the camera 218, and the position device 219 may be communicatively coupled to each other by a bus 220 (which may be configured, e.g., for optical and/or electrical communication). One or more of the shown apparatus (e.g., the camera 218, the position device 219, and/or one or more of the sensor(s) 213, etc.) may be omitted from the UE 200. The processor 210 may include one or more intelligent hardware devices, e.g., a central processing unit (CPU), a microcontroller, an application specific integrated circuit (ASIC), etc. The processor 210 may comprise multiple processors including a general-purpose/application processor 230, a Digital Signal Processor (DSP) 231, a modem processor 232, a video processor 233, and/or a sensor processor 234. One or more of the processors 230-234 may comprise multiple devices (e.g., multiple processors). For example, the sensor processor 234 may comprise, e.g., processors for RF (radio frequency) sensing (with one or more (cellular) wireless signals transmitted and reflection(s) used to identify, map, and/or track an object), and/or ultrasound, etc. The modem processor 232 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the UE 200 for connectivity. The memory 211 is a non-transitory storage medium that may include random access memory (RAM), flash memory, disc memory, and/or read-only memory (ROM), etc. The memory 211 stores the software 212 which may be processor-readable, processor-executable software code containing instructions that are configured to, when executed, cause the processor 210 to perform various functions described herein. Alternatively, the software 212 may not be directly executable by the processor 210 but may be configured to cause the processor 210, e.g., when compiled and executed, to perform the functions. The description may refer to the processor 210 performing a function, but this includes other implementations such as where the processor 210 executes software and/or firmware. The description may refer to the processor 210 performing a function as shorthand for one or more of the processors 230-234 performing the function. The description may refer to the UE 200 performing a function as shorthand for one or more appropriate components of the UE 200 performing the function. The processor 210 may include a memory with stored instructions in addition to and/or instead of the memory 211. Functionality of the processor 210 is discussed more fully below.

The configuration of the UE 200 shown in FIG. 2 is an example and not limiting of the disclosure, including the claims, and other configurations may be used. For example, an example configuration of the UE includes one or more of the processors 230-234 of the processor 210, the memory 211, and the wireless transceiver 240. Other example configurations include one or more of the processors 230-234 of the processor 210, the memory 211, a wireless transceiver, and one or more of the sensor(s) 213, the user interface 216, the SPS receiver 217, the camera 218, the PD 219, and/or a wired transceiver.

The UE 200 may comprise the modem processor 232 that may be capable of performing baseband processing of signals received and down-converted by the transceiver 215 and/or the SPS receiver 217. The modem processor 232 may perform baseband processing of signals to be upconverted for transmission by the transceiver 215. Also or alternatively, baseband processing may be performed by the processor 230 and/or the DSP 231. Other configurations, however, may be used to perform baseband processing.

The UE 200 may include the sensor(s) 213 that may include, for example, one or more of various types of sensors such as one or more inertial sensors, one or more magnetometers, one or more environment sensors, one or more optical sensors, one or more weight sensors, and/or one or more radio frequency (RF) sensors, etc. An inertial measurement unit (IMU) may comprise, for example, one or more accelerometers (e.g., collectively responding to acceleration of the UE 200 in three dimensions) and/or one or more gyroscopes (e.g., three-dimensional gyroscope(s)). The sensor(s) 213 may include one or more magnetometers (e.g., three-dimensional magnetometer(s)) to determine orientation (e.g., relative to magnetic north and/or true north) that may be used for any of a variety of purposes, e.g., to support one or more compass applications. The environment sensor(s) may comprise, for example, one or more temperature sensors, one or more barometric pressure sensors, one or more ambient light sensors, one or more camera imagers, and/or one or more microphones, etc. The sensor(s) 213 may generate analog and/or digital signals indications of which may be stored in the memory 211 and processed by the DSP 231 and/or the processor 230 in support of one or more applications such as, for example, applications directed to positioning and/or navigation operations.

The sensor(s) 213 may be used in relative location measurements, relative location determination, motion determination, etc. Information detected by the sensor(s) 213 may be used for motion detection, relative displacement, dead reckoning, sensor-based location determination, and/or sensor-assisted location determination. The sensor(s) 213 may be useful to determine whether the UE 200 is fixed (stationary) or mobile and/or whether to report certain useful information to the LMF 120 regarding the mobility of the UE 200. For example, based on the information obtained/measured by the sensor(s) 213, the UE 200 may notify/report to the LMF 120 that the UE 200 has detected movements or that the UE 200 has moved, and report the relative displacement/distance (e.g., via dead reckoning, or sensor-based location determination, or sensor-assisted location determination enabled by the sensor(s) 213). In another example, for relative positioning information, the sensors/IMU can be used to determine the angle and/or orientation of the other device with respect to the UE 200, etc.

The IMU may be configured to provide measurements about a direction of motion and/or a speed of motion of the UE 200, which may be used in relative location determination. For example, one or more accelerometers and/or one or more gyroscopes of the IMU may detect, respectively, a linear acceleration and a speed of rotation of the UE 200. The linear acceleration and speed of rotation measurements of the UE 200 may be integrated over time to determine an instantaneous direction of motion as well as a displacement of the UE 200. The instantaneous direction of motion and the displacement may be integrated to track a location of the UE 200. For example, a reference location of the UE 200 may be determined, e.g., using the SPS receiver 217 (and/or by some other means) for a moment in time and measurements from the accelerometer(s) and gyroscope(s) taken after this moment in time may be used in dead reckoning to determine present location of the UE 200 based on movement (direction and distance) of the UE 200 relative to the reference location.

The magnetometer(s) may determine magnetic field strengths in different directions which may be used to determine orientation of the UE 200. For example, the orientation may be used to provide a digital compass for the UE 200. The magnetometer(s) may include a two-dimensional magnetometer configured to detect and provide indications of magnetic field strength in two orthogonal dimensions. The magnetometer(s) may include a three-dimensional magnetometer configured to detect and provide indications of magnetic field strength in three orthogonal dimensions. The magnetometer(s) may provide means for sensing a magnetic field and providing indications of the magnetic field, e.g., to the processor 210.

The transceiver 215 may include a wireless transceiver 240 and a wired transceiver 250 configured to communicate with other devices through wireless connections and wired connections, respectively. For example, the wireless transceiver 240 may include a wireless transmitter 242 and a wireless receiver 244 coupled to an antenna 246 for transmitting (e.g., on one or more uplink channels and/or one or more sidelink channels) and/or receiving (e.g., on one or more downlink channels and/or one or more sidelink channels) wireless signals 248 and transducing signals from the wireless signals 248 to wired (e.g., electrical and/or optical) signals and from wired (e.g., electrical and/or optical) signals to the wireless signals 248. Thus, the wireless transmitter 242 may include multiple transmitters that may be discrete components or combined/integrated components, and/or the wireless receiver 244 may include multiple receivers that may be discrete components or combined/integrated components. The wireless transceiver 240 may be configured to communicate signals (e.g., with TRPs and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. New Radio may use mm-wave frequencies and/or sub-6 GHz frequencies. The wired transceiver 250 may include a wired transmitter 252 and a wired receiver 254 configured for wired communication, e.g., a network interface that may be utilized to communicate with the NG-RAN 135 to send communications to, and receive communications from, the NG-RAN 135. The wired transmitter 252 may include multiple transmitters that may be discrete components or combined/integrated components, and/or the wired receiver 254 may include multiple receivers that may be discrete components or combined/integrated components. The wired transceiver 250 may be configured, e.g., for optical communication and/or electrical communication. The transceiver 215 may be communicatively coupled to the transceiver interface 214, e.g., by optical and/or electrical connection. The transceiver interface 214 may be at least partially integrated with the transceiver 215. The wireless transmitter 242, the wireless receiver 244, and/or the antenna 246 may include multiple transmitters, multiple receivers, and/or multiple antennas, respectively, for sending and/or receiving, respectively, appropriate signals.

The user interface 216 may comprise one or more of several devices such as, for example, a speaker, microphone, display device, vibration device, keyboard, touch screen, etc. The user interface 216 may include more than one of any of these devices. The user interface 216 may be configured to enable a user to interact with one or more applications hosted by the UE 200. For example, the user interface 216 may store indications of analog and/or digital signals in the memory 211 to be processed by DSP 231 and/or the general-purpose processor 230 in response to action from a user. Similarly, applications hosted on the UE 200 may store indications of analog and/or digital signals in the memory 211 to present an output signal to a user. The user interface 216 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also or alternatively, the user interface 216 may comprise one or more touch sensors responsive to touching and/or pressure, e.g., on a keyboard and/or touch screen of the user interface 216.

The SPS receiver 217 (e.g., a Global Positioning System (GPS) receiver) may be capable of receiving and acquiring SPS signals 260 via an SPS antenna 262. The SPS antenna 262 is configured to transduce the SPS signals 260 from wireless signals to wired signals, e.g., electrical or optical signals, and may be integrated with the antenna 246. The SPS receiver 217 may be configured to process, in whole or in part, the acquired SPS signals 260 for estimating a location of the UE 200. For example, the SPS receiver 217 may be configured to determine location of the UE 200 by trilateration using the SPS signals 260. The general-purpose processor 230, the memory 211, the DSP 231 and/or one or more specialized processors (not shown) may be utilized to process acquired SPS signals, in whole or in part, and/or to calculate an estimated location of the UE 200, in conjunction with the SPS receiver 217. The memory 211 may store indications (e.g., measurements) of the SPS signals 260 and/or other signals (e.g., signals acquired from the wireless transceiver 240) for use in performing positioning operations. The general-purpose processor 230, the DSP 231, and/or one or more specialized processors, and/or the memory 211 may provide or support a location engine for use in processing measurements to estimate a location of the UE 200.

The UE 200 may include the camera 218 for capturing still or moving imagery. The camera 218 may comprise, for example, an imaging sensor (e.g., a charge coupled device or a CMOS imager), a lens, analog-to-digital circuitry, frame buffers, etc. Additional processing, conditioning, encoding, and/or compression of signals representing captured images may be performed by the general-purpose processor 230 and/or the DSP 231. Also or alternatively, the video processor 233 may perform conditioning, encoding, compression, and/or manipulation of signals representing captured images. The video processor 233 may decode/decompress stored image data for presentation on a display device (not shown), e.g., of the user interface 216.

The position device (PD) 219 may be configured to determine a position of the UE 200, motion of the UE 200, and/or relative position of the UE 200, and/or time. For example, the PD 219 may communicate with, and/or include some or all of, the SPS receiver 217. The PD 219 may work in conjunction with the processor 210 and the memory 211 as appropriate to perform at least a portion of one or more positioning methods, although the description herein may refer to the PD 219 being configured to perform, or performing, in accordance with the positioning method(s). The PD 219 may also or alternatively be configured to determine location of the UE 200 using terrestrial-based signals (e.g., at least some of the wireless signals 248) for trilateration, for assistance with obtaining and using the SPS signals 260, or both. The PD 219 may be configured to determine location of the UE 200 based on a cell of a serving base station (e.g., a cell center) and/or another technique such as E-CID. The PD 219 may be configured to use one or more images from the camera 218 and image recognition combined with known locations of landmarks (e.g., natural landmarks such as mountains and/or artificial landmarks such as buildings, bridges, streets, etc.) to determine location of the UE 200. The PD 219 may be configured to use one or more other techniques (e.g., relying on the UE's self-reported location (e.g., part of the UE's position beacon)) for determining the location of the UE 200, and may use a combination of techniques (e.g., SPS and terrestrial positioning signals) to determine the location of the UE 200. The PD 219 may include one or more of the sensors 213 (e.g., gyroscope(s), accelerometer(s), magnetometer(s), etc.) that may sense orientation and/or motion of the UE 200 and provide indications thereof that the processor 210 (e.g., the processor 230 and/or the DSP 231) may be configured to use to determine motion (e.g., a velocity vector and/or an acceleration vector) of the UE 200. The PD 219 may be configured to provide indications of uncertainty and/or error in the determined position and/or motion. Functionality of the PD 219 may be provided in a variety of manners and/or configurations, e.g., by the general purpose/application processor 230, the transceiver 215, the SPS receiver 217, and/or another component of the UE 200, and may be provided by hardware, software, firmware, or various combinations thereof.

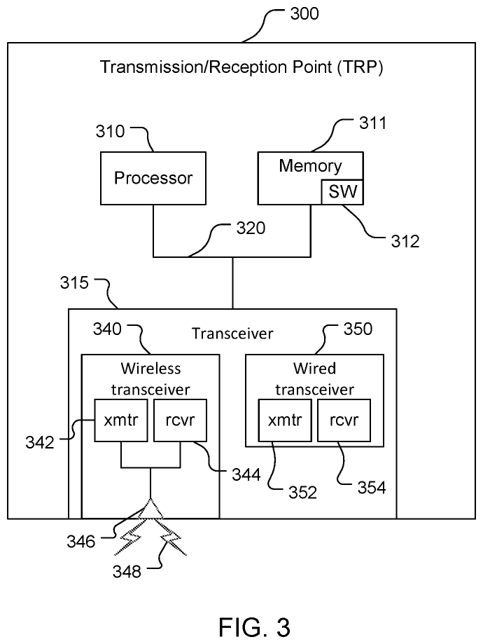

Referring also to FIG. 3, an example of a TRP 300 of the gNBs 110a, 110b and/or the ng-eNB 114 comprises a computing platform including a processor 310, memory 311 including software (SW) 312, and a transceiver 315. The processor 310, the memory 311, and the transceiver 315 may be communicatively coupled to each other by a bus 320 (which may be configured, e.g., for optical and/or electrical communication). One or more of the shown apparatus (e.g., a wireless interface) may be omitted from the TRP 300. The processor 310 may include one or more intelligent hardware devices, e.g., a central processing unit (CPU), a microcontroller, an application specific integrated circuit (ASIC), etc. The processor 310 may comprise multiple processors (e.g., including a general-purpose/application processor, a DSP, a modem processor, a video processor, and/or a sensor processor as shown in FIG. 2). The memory 311 is a non-transitory storage medium that may include random access memory (RAM)), flash memory, disc memory, and/or read-only memory (ROM), etc. The memory 311 stores the software 312 which may be processor-readable, processor-executable software code containing instructions that are configured to, when executed, cause the processor 310 to perform various functions described herein. Alternatively, the software 312 may not be directly executable by the processor 310 but may be configured to cause the processor 310, e.g., when compiled and executed, to perform the functions.

The description may refer to the processor 310 performing a function, but this includes other implementations such as where the processor 310 executes software and/or firmware. The description may refer to the processor 310 performing a function as shorthand for one or more of the processors contained in the processor 310 performing the function. The description may refer to the TRP 300 performing a function as shorthand for one or more appropriate components (e.g., the processor 310 and the memory 311) of the TRP 300 (and thus of one of the gNBs 110a, 110b and/or the ng-eNB 114) performing the function. The processor 310 may include a memory with stored instructions in addition to and/or instead of the memory 311. Functionality of the processor 310 is discussed more fully below.

The transceiver 315 may include a wireless transceiver 340 and/or a wired transceiver 350 configured to communicate with other devices through wireless connections and wired connections, respectively. For example, the wireless transceiver 340 may include a wireless transmitter 342 and a wireless receiver 344 coupled to one or more antennas 346 for transmitting (e.g., on one or more uplink channels and/or one or more downlink channels) and/or receiving (e.g., on one or more downlink channels and/or one or more uplink channels) wireless signals 348 and transducing signals from the wireless signals 348 to wired (e.g., electrical and/or optical) signals and from wired (e.g., electrical and/or optical) signals to the wireless signals 348. Thus, the wireless transmitter 342 may include multiple transmitters that may be discrete components or combined/integrated components, and/or the wireless receiver 344 may include multiple receivers that may be discrete components or combined/integrated components. The wireless transceiver 340 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. The wired transceiver 350 may include a wired transmitter 352 and a wired receiver 354 configured for wired communication, e.g., a network interface that may be utilized to communicate with the NG-RAN 135 to send communications to, and receive communications from, the LMF 120, for example, and/or one or more other network entities. The wired transmitter 352 may include multiple transmitters that may be discrete components or combined/integrated components, and/or the wired receiver 354 may include multiple receivers that may be discrete components or combined/integrated components. The wired transceiver 350 may be configured, e.g., for optical communication and/or electrical communication.

The configuration of the TRP 300 shown in FIG. 3 is an example and not limiting of the disclosure, including the claims, and other configurations may be used. For example, the description herein discusses that the TRP 300 is configured to perform or performs several functions, but one or more of these functions may be performed by the LMF 120 and/or the UE 200 (i.e., the LMF 120 and/or the UE 200 may be configured to perform one or more of these functions).

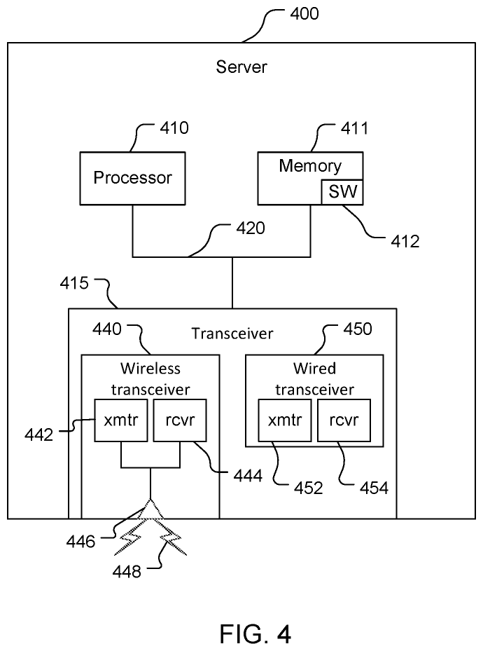

Referring also to FIG. 4, a server 400, of which the LMF 120 is an example, comprises a computing platform including a processor 410, memory 411 including software (SW) 412, and a transceiver 415. The processor 410, the memory 411, and the transceiver 415 may be communicatively coupled to each other by a bus 420 (which may be configured, e.g., for optical and/or electrical communication). One or more of the shown apparatus (e.g., a wireless interface) may be omitted from the server 400. The processor 410 may include one or more intelligent hardware devices, e.g., a central processing unit (CPU), a microcontroller, an application specific integrated circuit (ASIC), etc. The processor 410 may comprise multiple processors (e.g., including a general-purpose/application processor, a DSP, a modem processor, a video processor, and/or a sensor processor as shown in FIG. 2). The memory 411 is a non-transitory storage medium that may include random access memory (RAM)), flash memory, disc memory, and/or read-only memory (ROM), etc. The memory 411 stores the software 412 which may be processor-readable, processor-executable software code containing instructions that are configured to, when executed, cause the processor 410 to perform various functions described herein. Alternatively, the software 412 may not be directly executable by the processor 410 but may be configured to cause the processor 410, e.g., when compiled and executed, to perform the functions. The description may refer to the processor 410 performing a function, but this includes other implementations such as where the processor 410 executes software and/or firmware. The description may refer to the processor 410 performing a function as shorthand for one or more of the processors contained in the processor 410 performing the function. The description may refer to the server 400 performing a function as shorthand for one or more appropriate components of the server 400 performing the function. The processor 410 may include a memory with stored instructions in addition to and/or instead of the memory 411. Functionality of the processor 410 is discussed more fully below.

The transceiver 415 may include a wireless transceiver 440 and/or a wired transceiver 450 configured to communicate with other devices through wireless connections and wired connections, respectively. For example, the wireless transceiver 440 may include a wireless transmitter 442 and a wireless receiver 444 coupled to one or more antennas 446 for transmitting (e.g., on one or more downlink channels) and/or receiving (e.g., on one or more uplink channels) wireless signals 448 and transducing signals from the wireless signals 448 to wired (e.g., electrical and/or optical) signals and from wired (e.g., electrical and/or optical) signals to the wireless signals 448. Thus, the wireless transmitter 442 may include multiple transmitters that may be discrete components or combined/integrated components, and/or the wireless receiver 444 may include multiple receivers that may be discrete components or combined/integrated components. The wireless transceiver 440 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. The wired transceiver 450 may include a wired transmitter 452 and a wired receiver 454 configured for wired communication, e.g., a network interface that may be utilized to communicate with the NG-RAN 135 to send communications to, and receive communications from, the TRP 300, for example, and/or one or more other network entities. The wired transmitter 452 may include multiple transmitters that may be discrete components or combined/integrated components, and/or the wired receiver 454 may include multiple receivers that may be discrete components or combined/integrated components. The wired transceiver 450 may be configured, e.g., for optical communication and/or electrical communication.

The description herein may refer to the processor 410 performing a function, but this includes other implementations such as where the processor 410 executes software (stored in the memory 411) and/or firmware. The description herein may refer to the server 400 performing a function as shorthand for one or more appropriate components (e.g., the processor 410 and the memory 411) of the server 400 performing the function.

The configuration of the server 400 shown in FIG. 4 is an example and not limiting of the disclosure, including the claims, and other configurations may be used. For example, the wireless transceiver 440 may be omitted. Also or alternatively, the description herein discusses that the server 400 is configured to perform or performs several functions, but one or more of these functions may be performed by the TRP 300 and/or the UE 200 (i.e., the TRP 300 and/or the UE 200 may be configured to perform one or more of these functions).

Positioning Techniques

For terrestrial positioning of a UE in cellular networks, techniques such as Advanced Forward Link Trilateration (AFLT) and Observed Time Difference Of Arrival (OTDOA) often operate in “UE-assisted” mode in which measurements of reference signals (e.g., PRS, CRS, etc.) transmitted by base stations are taken by the UE and then provided to a location server. The location server then calculates the position of the UE based on the measurements and known locations of the base stations. Because these techniques use the location server to calculate the position of the UE, rather than the UE itself, these positioning techniques are not frequently used in applications such as car or cell-phone navigation, which instead typically rely on satellite-based positioning.

A UE may use a Satellite Positioning System (SPS) (a Global Navigation Satellite System (GNSS)) for high-accuracy positioning using precise point positioning (PPP) or real time kinematic (RTK) technology. These technologies use assistance data such as measurements from ground-based stations. LTE Release 15 allows the data to be encrypted so that the UEs subscribed to the service exclusively can read the information. Such assistance data varies with time. Thus, a UE subscribed to the service may not easily “break encryption” for other UEs by passing on the data to other UEs that have not paid for the subscription. The passing on would need to be repeated every time the assistance data changes.

In UE-assisted positioning, the UE sends measurements (e.g., TDOA, Angle of Arrival (AoA), etc.) to the positioning server (e.g., LMF/eSMLC). The positioning server has the base station almanac (BSA) that contains multiple ‘entries’ or ‘records’, one record per cell, where each record contains geographical cell location but also may include other data. An identifier of the ‘record’ among the multiple ‘records’ in the BSA may be referenced. The BSA and the measurements from the UE may be used to compute the position of the UE.

In conventional UE-based positioning, a UE computes its own position, thus avoiding sending measurements to the network (e.g., location server), which in turn improves latency and scalability. The UE uses relevant BSA record information (e.g., locations of gNBs (more broadly base stations)) from the network. The BSA information may be encrypted. But since the BSA information varies much less often than, for example, the PPP or RTK assistance data described earlier, it may be easier to make the BSA information (compared to the PPP or RTK information) available to UEs that did not subscribe and pay for decryption keys. Transmissions of reference signals by the gNBs make BSA information potentially accessible to crowd-sourcing or war-driving, essentially enabling BSA information to be generated based on in-the-field and/or over-the-top observations.

Positioning techniques may be characterized and/or assessed based on one or more criteria such as position determination accuracy and/or latency. Latency is a time elapsed between an event that triggers determination of position-related data and the availability of that data at a positioning system interface, e.g., an interface of the LMF 120. At initialization of a positioning system, the latency for the availability of position-related data is called time to first fix (TTFF), and is larger than latencies after the TTFF. An inverse of a time elapsed between two consecutive position-related data availabilities is called an update rate, i.e., the rate at which position-related data are generated after the first fix. Latency may depend on processing capability, e.g., of the UE. For example, a UE may report a processing capability of the UE as a duration of DL PRS symbols in units of time (e.g., milliseconds) that the UE can process every T amount of time (e.g., T ms) assuming 272 PRB (Physical Resource Block) allocation. Other examples of capabilities that may affect latency are a number of TRPs from which the UE can process PRS, a number of PRS that the UE can process, and a bandwidth of the UE.

One or more of many different positioning techniques (also called positioning methods) may be used to determine position of an entity such as one of the UEs 105, 106. For example, known position-determination techniques include RTT, multi-RTT, OTDOA (also called TDOA and including UL-TDOA and DL-TDOA), Enhanced Cell Identification (E-CID), DL-AoD, UL-AoA, etc. RTT uses a time for a signal to travel from one entity to another and back to determine a range between the two entities. The range, plus a known location of a first one of the entities and an angle between the two entities (e.g., an azimuth angle) can be used to determine a location of the second of the entities. In multi-RTT (also called multi-cell RTT), multiple ranges from one entity (e.g., a UE) to other entities (e.g., TRPs) and known locations of the other entities may be used to determine the location of the one entity. In TDOA techniques, the difference in travel times between one entity and other entities may be used to determine relative ranges from the other entities and those, combined with known locations of the other entities may be used to determine the location of the one entity. Angles of arrival and/or departure may be used to help determine location of an entity. For example, an angle of arrival or an angle of departure of a signal combined with a range between devices (determined using signal, e.g., a travel time of the signal, a received power of the signal, etc.) and a known location of one of the devices may be used to determine a location of the other device. The angle of arrival or departure may be an azimuth angle relative to a reference direction such as true north. The angle of arrival or departure may be a zenith angle relative to directly upward from an entity (i.e., relative to radially outward from a center of Earth). E-CID uses the identity of a serving cell, the timing advance (i.e., the difference between receive and transmit times at the UE), estimated timing and power of detected neighbor cell signals, and possibly angle of arrival (e.g., of a signal at the UE from the base station or vice versa) to determine location of the UE. In TDOA, the difference in arrival times at a receiving device of signals from different sources along with known locations of the sources and known offset of transmission times from the sources are used to determine the location of the receiving device.

In a network-centric RTT estimation, the serving base station instructs the UE to scan for/receive RTT measurement signals (e.g., PRS) on serving cells of two or more neighboring base stations (and typically the serving base station, as at least three base stations are needed). The one of more base stations transmit RTT measurement signals on low reuse resources (e.g., resources used by the base station to transmit system information) allocated by the network (e.g., a location server such as the LMF 120). The UE records the arrival time (also referred to as a receive time, a reception time, a time of reception, or a time of arrival (ToA)) of each RTT measurement signal relative to the UE's current downlink timing (e.g., as derived by the UE from a DL signal received from its serving base station), and transmits a common or individual RTT response message (e.g., SRS (sounding reference signal) for positioning, i.e., UL-PRS) to the one or more base stations (e.g., when instructed by its serving base station) and may include the time difference T_{Rx→Tx} (i.e., UE T_{Rx-Tx} or UE_{Rx-Tx}) between the ToA of the RTT measurement signal and the transmission time of the RTT response message in a payload of each RTT response message. The RTT response message would include a reference signal from which the base station can deduce the ToA of the RTT response. By comparing the difference T_{Tx→Rx} between the transmission time of the RTT measurement signal from the base station and the ToA of the RTT response at the base station to the UE-reported time difference T_{Rx→Tx}, the base station can deduce the propagation time between the base station and the UE, from which the base station can determine the distance between the UE and the base station by assuming the speed of light during this propagation time.

A UE-centric RTT estimation is similar to the network-based method, except that the UE transmits uplink RTT measurement signal(s) (e.g., when instructed by a serving base station), which are received by multiple base stations in the neighborhood of the UE. Each involved base station responds with a downlink RTT response message, which may include the time difference between the ToA of the RTT measurement signal at the base station and the transmission time of the RTT response message from the base station in the RTT response message payload.

For both network-centric and UE-centric procedures, the side (network or UE) that performs the RTT calculation typically (though not always) transmits the first message(s) or signal(s) (e.g., RTT measurement signal(s)), while the other side responds with one or more RTT response message(s) or signal(s) that may include the difference between the ToA of the first message(s) or signal(s) and the transmission time of the RTT response message(s) or signal(s).

A multi-RTT technique may be used to determine position. For example, a first entity (e.g., a UE) may send out one or more signals (e.g., unicast, multicast, or broadcast from the base station) and multiple second entities (e.g., other TSPs such as base station(s) and/or UE(s)) may receive a signal from the first entity and respond to this received signal. The first entity receives the responses from the multiple second entities. The first entity (or another entity such as an LMF) may use the responses from the second entities to determine ranges to the second entities and may use the multiple ranges and known locations of the second entities to determine the location of the first entity by trilateration.

In some instances, additional information may be obtained in the form of an angle of arrival (AoA) or angle of departure (AoD) that defines a straight-line direction (e.g., which may be in a horizontal plane or in three dimensions) or possibly a range of directions (e.g., for the UE from the locations of base stations). The intersection of two directions can provide another estimate of the location for the UE.

For positioning techniques using PRS (Positioning Reference Signal) signals (e.g., TDOA and RTT), PRS signals sent by multiple TRPs are measured and the arrival times of the signals, known transmission times, and known locations of the TRPs used to determine ranges from a UE to the TRPs. For example, an RSTD (Reference Signal Time Difference) may be determined for PRS signals received from multiple TRPs and used in a TDOA technique to determine position (location) of the UE. A positioning reference signal may be referred to as a PRS or a PRS signal. The PRS signals are typically sent using the same power and PRS signals with the same signal characteristics (e.g., same frequency shift) may interfere with each other such that a PRS signal from a more distant TRP may be overwhelmed by a PRS signal from a closer TRP such that the signal from the more distant TRP may not be detected. PRS muting may be used to help reduce interference by muting some PRS signals (reducing the power of the PRS signal, e.g., to zero and thus not transmitting the PRS signal). In this way, a weaker (at the UE) PRS signal may be more easily detected by the UE without a stronger PRS signal interfering with the weaker PRS signal. The term RS, and variations thereof (e.g., PRS, SRS, CSI-RS ((Channel State Information-Reference Signal)), may refer to one reference signal or more than one reference signal.

Positioning reference signals (PRS) include downlink PRS (DL PRS, often referred to simply as PRS) and uplink PRS (UL PRS) (which may be called SRS (Sounding Reference Signal) for positioning). A PRS may comprise a PN code (pseudorandom number code) or be generated using a PN code (e.g., by modulating a carrier signal with the PN code) such that a source of the PRS may serve as a pseudo-satellite (a pseudolite). The PN code may be unique to the PRS source (at least within a specified area such that identical PRS from different PRS sources do not overlap). PRS may comprise PRS resources or PRS resource sets of a frequency layer. A DL PRS positioning frequency layer (or simply a frequency layer) is a collection of DL PRS resource sets, from one or more TRPs, with PRS resource(s) that have common parameters configured by higher-layer parameters DL-PRS-PositioningFrequencyLayer, DL-PRS-ResourceSet, and DL-PRS-Resource. Each frequency layer has a DL PRS subcarrier spacing (SCS) for the DL PRS resource sets and the DL PRS resources in the frequency layer. Each frequency layer has a DL PRS cyclic prefix (CP) for the DL PRS resource sets and the DL PRS resources in the frequency layer. In 5G, a resource block occupies 12 consecutive subcarriers and a specified number of symbols. Also, a DL PRS Point A parameter defines a frequency of a reference resource block (and the lowest subcarrier of the resource block), with DL PRS resources belonging to the same DL PRS resource set having the same Point A and all DL PRS resource sets belonging to the same frequency layer having the same Point A. A frequency layer also has the same DL PRS bandwidth, the same start PRB (and center frequency), and the same value of comb size (i.e., a frequency of PRS resource elements per symbol such that for comb-N, every N^{th} resource element is a PRS resource element). A PRS resource set is identified by a PRS resource set ID and may be associated with a particular TRP (identified by a cell ID) transmitted by an antenna panel of a base station. A PRS resource ID in a PRS resource set may be associated with an omnidirectional signal, and/or with a single beam (and/or beam ID) transmitted from a single base station (where a base station may transmit one or more beams). Each PRS resource of a PRS resource set may be transmitted on a different beam and as such, a PRS resource, or simply resource can also be referred to as a beam. This does not have any implications on whether the base stations and the beams on which PRS are transmitted are known to the UE.

A TRP may be configured, e.g., by instructions received from a server and/or by software in the TRP, to send DL PRS per a schedule. According to the schedule, the TRP may send the DL PRS intermittently, e.g., periodically at a consistent interval from an initial transmission. The TRP may be configured to send one or more PRS resource sets. A resource set is a collection of PRS resources across one TRP, with the resources having the same periodicity, a common muting pattern configuration (if any), and the same repetition factor across slots. Each of the PRS resource sets comprises multiple PRS resources, with each PRS resource comprising multiple Resource Elements (REs) that may be in multiple Resource Blocks (RBs) within N (one or more) consecutive symbol(s) within a slot. An RB is a collection of REs spanning a quantity of one or more consecutive symbols in the time domain and a quantity (12 for a 5G RB) of consecutive sub-carriers in the frequency domain. Each PRS resource is configured with an RE offset, slot offset, a symbol offset within a slot, and a number of consecutive symbols that the PRS resource may occupy within a slot. The RE offset defines the starting RE offset of the first symbol within a DL PRS resource in frequency. The relative RE offsets of the remaining symbols within a DL PRS resource are defined based on the initial offset. The slot offset is the starting slot of the DL PRS resource with respect to a corresponding resource set slot offset. The symbol offset determines the starting symbol of the DL PRS resource within the starting slot. Transmitted REs may repeat across slots, with each transmission being called a repetition such that there may be multiple repetitions in a PRS resource. The DL PRS resources in a DL PRS resource set are associated with the same TRP and each DL PRS resource has a DL PRS resource ID. A DL PRS resource ID in a DL PRS resource set is associated with a single beam transmitted from a single TRP (although a TRP may transmit one or more beams).

A PRS resource may also be defined by quasi-co-location and start PRB parameters. A quasi-co-location (QCL) parameter may define any quasi-co-location information of the DL PRS resource with other reference signals. The DL PRS may be configured to be QCL type D with a DL PRS or SS/PBCH (Synchronization Signal/Physical Broadcast Channel) Block from a serving cell or a non-serving cell. The DL PRS may be configured to be QCL type C with an SS/PBCH Block from a serving cell or a non-serving cell. The start PRB parameter defines the starting PRB index of the DL PRS resource with respect to reference Point A. The starting PRB index has a granularity of one PRB and may have a minimum value of 0 and a maximum value of 2176 PRBs.

A PRS resource set is a collection of PRS resources with the same periodicity, same muting pattern configuration (if any), and the same repetition factor across slots. Every time all repetitions of all PRS resources of the PRS resource set are configured to be transmitted is referred as an “instance”. Therefore, an “instance” of a PRS resource set is a specified number of repetitions for each PRS resource and a specified number of PRS resources within the PRS resource set such that once the specified number of repetitions are transmitted for each of the specified number of PRS resources, the instance is complete. An instance may also be referred to as an “occasion.” A DL PRS configuration including a DL PRS transmission schedule may be provided to a UE to facilitate (or even enable) the UE to measure the DL PRS.

Multiple frequency layers of PRS may be aggregated to provide an effective bandwidth that is larger than any of the bandwidths of the layers individually. Multiple frequency layers of component carriers (which may be consecutive and/or separate) and meeting criteria such as being quasi co-located (QCLed), and having the same antenna port, may be stitched to provide a larger effective PRS bandwidth (for DL PRS and UL PRS) resulting in increased time of arrival measurement accuracy. Stitching comprises combining PRS measurements over individual bandwidth fragments into a unified piece such that the stitched PRS may be treated as having been taken from a single measurement. Being QCLed, the different frequency layers behave similarly, enabling stitching of the PRS to yield the larger effective bandwidth. The larger effective bandwidth, which may be referred to as the bandwidth of an aggregated PRS or the frequency bandwidth of an aggregated PRS, provides for better time-domain resolution (e.g., of TDOA). An aggregated PRS includes a collection of PRS resources and each PRS resource of an aggregated PRS may be called a PRS component, and each PRS component may be transmitted on different component carriers, bands, or frequency layers, or on different portions of the same band.

RTT positioning is an active positioning technique in that RTT uses positioning signals sent by TRPs to UEs and by UEs (that are participating in RTT positioning) to TRPs. The TRPs may send DL-PRS signals that are received by the UEs and the UEs may send SRS (Sounding Reference Signal) signals that are received by multiple TRPs. A sounding reference signal may be referred to as an SRS or an SRS signal. In 5G multi-RTT, coordinated positioning may be used with the UE sending a single UL-SRS for positioning that is received by multiple TRPs instead of sending a separate UL-SRS for positioning for each TRP. A TRP that participates in multi-RTT will typically search for UEs that are currently camped on that TRP (served UEs, with the TRP being a serving TRP) and also UEs that are camped on neighboring TRPs (neighbor UEs). Neighbor TRPs may be TRPs of a single BTS (e.g., gNB), or may be a TRP of one BTS and a TRP of a separate BTS. For RTT positioning, including multi-RTT positioning, the DL-PRS signal and the UL-SRS for positioning signal in a PRS/SRS for positioning signal pair used to determine RTT (and thus used to determine range between the UE and the TRP) may occur close in time to each other such that errors due to UE motion and/or UE clock drift and/or TRP clock drift are within acceptable limits. For example, signals in a PRS/SRS for positioning signal pair may be transmitted from the TRP and the UE, respectively, within about 10 ms of each other. With SRS for positioning signals being sent by UEs, and with PRS and SRS for positioning signals being conveyed close in time to each other, it has been found that radio-frequency (RF) signal congestion may result (which may cause excessive noise, etc.) especially if many UEs attempt positioning concurrently and/or that computational congestion may result at the TRPs that are trying to measure many UEs concurrently.

RTT positioning may be UE-based or UE-assisted. In UE-based RTT, the UE 200 determines the RTT and corresponding range to each of the TRPs 300 and the position of the UE 200 based on the ranges to the TRPs 300 and known locations of the TRPs 300. In UE-assisted RTT, the UE 200 measures positioning signals and provides measurement information to the TRP 300, and the TRP 300 determines the RTT and range. The TRP 300 provides ranges to a location server, e.g., the server 400, and the server determines the location of the UE 200, e.g., based on ranges to different TRPs 300. The RTT and/or range may be determined by the TRP 300 that received the signal(s) from the UE 200, by this TRP 300 in combination with one or more other devices, e.g., one or more other TRPs 300 and/or the server 400, or by one or more devices other than the TRP 300 that received the signal(s) from the UE 200.

Various positioning techniques are supported in 5G NR. The NR native positioning methods supported in 5G NR include DL-only positioning methods, UL-only positioning methods, and DL+UL positioning methods. Downlink-based positioning methods include DL-TDOA and DL-AoD. Uplink-based positioning methods include UL-TDOA and UL-AoA. Combined DL+UL-based positioning methods include RTT with one base station and RTT with multiple base stations (multi-RTT).

A position estimate (e.g., for a UE) may be referred to by other names, such as a location estimate, location, position, position fix, fix, or the like. A position estimate may be geodetic and comprise coordinates (e.g., latitude, longitude, and possibly altitude) or may be civic and comprise a street address, postal address, or some other verbal description of a location. A position estimate may further be defined relative to some other known location or defined in absolute terms (e.g., using latitude, longitude, and possibly altitude). A position estimate may include an expected error or uncertainty (e.g., by including an area or volume within which the location is expected to be included with some specified or default level of confidence).

Positioning with Angle Assistance

Angle information regarding reference signals received by a UE may be useful for several reasons. For example, knowing (e.g., by determining) the angle of arrival of a reference signal may be useful in determining a location of the UE. As another example, knowing the angle(s) of arrival of one or more reflected signals may be used for RF sensing, to determine information about an environment of the UE, e.g., quantities, sizes, and/or locations of objects of interest. Reflector locations may be mapped to objects of interest. Reflections may also or alternatively be used to determine virtual base station (e.g., gNB) locations and improve positioning accuracy of UE position. Consequently, UEs may attempt to determine angles of arrival of reference signals. It may be beneficial, e.g., to reduce latency and/or reduce power consumption, to have assistance information to facilitate determination of the angle(s) of arrival. For example, a UE may use a range of expected angle of arrival for a reference signal to reduce a search window for receiving and measuring the reference signal, which may improve computational cost (e.g., latency, processing power).

Angle information of one or more reference signals may be helpful with multipath mitigation. For example, knowing a range of expected angle of arrival may help with multipath mitigation, e.g., ignoring undesired multipath signals and/or using multipath signals (e.g., to characterize an environment, help with positioning, etc.). Further measurements supporting multipath mitigation include timing, power K-factor, and Doppler shift measurement of a line-of-sight (LOS) path and one or more non-line-of-sight (NLOS) paths. Assistance data may be provided to UEs for use in determining measurements supporting multipath mitigation, positioning, etc. For example, expected timing of reference signals may be provided, e.g., an expected time of receipt and an uncertainty in the time of receipt, thus providing a time window for receipt of a reference signal. For example, for DL PRS in FR1, an uncertainty may be +/−32 μs and an uncertainty for DL PRS in FR2 may be +/−8 μs. To date, however, angle assistance data have not been provided to UEs.

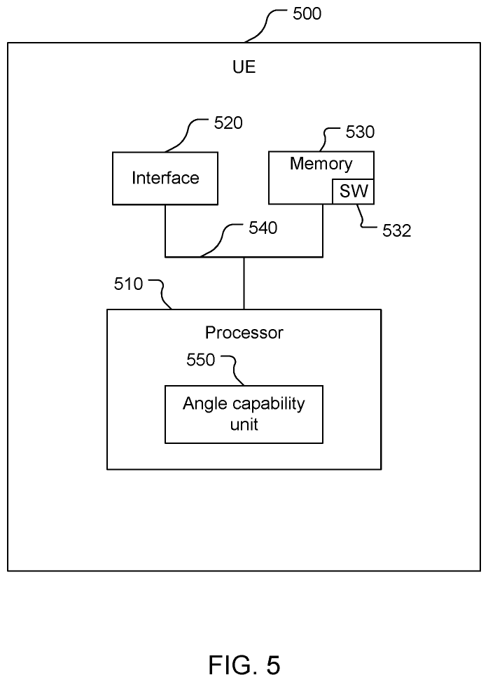

Referring to FIG. 5, with further reference to FIGS. 1-4, a UE 500 includes a processor 510, an interface 520, and a memory 530 communicatively coupled to each other by a bus 540. The UE 500 may include some or all of the components shown in FIG. 5, and may include one or more other components such as any of those shown in FIG. 2 such that the UE 200 may be an example of the UE 500. The processor 510 may include one or more components of the processor 210. The memory 530 is a non-transitory storage medium that may include RAM, flash memory, disc memory, and/or ROM, etc. The memory 530 may store software 532 which may be processor-readable, processor-executable software code containing instructions that are configured to, when executed, cause the processor 510 to perform various functions described herein. Alternatively, the software 532 may not be directly executable by the processor 510 but may be configured to cause the processor 510, e.g., when compiled and executed, to perform the functions. The interface 520 may include one or more of the components of the transceiver 215, e.g., the wireless transmitter 242 and the antenna 246, or the wireless receiver 244 and the antenna 246, or the wireless transmitter 242, the wireless receiver 244, and the antenna 246. Also or alternatively, the interface 520 may include the wired transmitter 252 and/or the wired receiver 254. The interface 520 may include the SPS receiver 217 and the SPS antenna 262.

The description herein may refer to the processor 510 performing a function, but this includes other implementations such as where the processor 510 executes software (stored in the memory 530) and/or firmware. The description herein may refer to the UE 500 performing a function as shorthand for one or more appropriate components (e.g., the processor 510 and the memory 530) of the UE 500 performing the function. The processor 510 (possibly in conjunction with the memory 530 and, as appropriate, the interface 520) includes an angle capability unit 550. The angle capability unit 550 may be configured to send one or more capability messages indicating an ability of the UE 500 to use angle information regarding reference signals in order to measure the reference signals. The capability message(s) may indicate one or more parameters regarding the ability of the UE 500 to use the angle information, e.g., a range of angles relative to the UE 500 over which the UE 500 may direct a beam for measuring a reference signal, one or more frequency bands and/or one or more frequency band combinations corresponding to one or more other parameters regarding the ability of the UE 500 to use angle information, etc. The configuration and functionality of the angle capability unit 550 is discussed further herein, and the UE 500 (e.g., the processor 510 and one or more other components as appropriate, such as the memory 530) is configured to perform the functions of the angle capability unit 550 discussed herein.

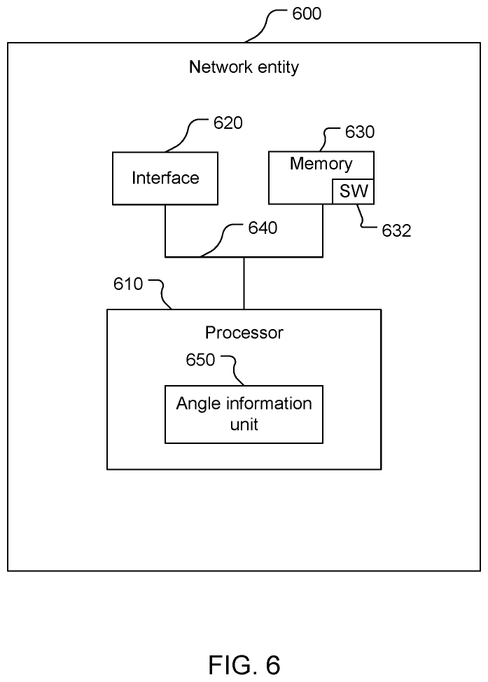

Referring to FIG. 6, with further reference to FIGS. 2 and 3, a network entity 600, which may be an example of the TRP 300 shown in FIG. 3, an example of the server 400 shown in FIG. 4, or a combination thereof (e.g. a TRP that includes an LMF), includes a processor 610, an interface 620, and a memory 630 communicatively coupled to each other by a bus 640. The network entity 600 may include some or all of the components shown in FIG. 6, and may include one or more other components such as any of those shown in FIG. 3 and/or FIG. 4. For example, the interface 620 may include one or more of the components of the transceiver 315, e.g., the wireless transmitter 342 and the antenna 346, or the wireless receiver 344 and the antenna 346, or the wireless transmitter 342, the wireless receiver 344, and the antenna 346. Also or alternatively, the interface 620 may include the wired transmitter 352 and/or the wired receiver 354. The memory 630 is a non-transitory storage medium that may include RAM, flash memory, disc memory, and/or ROM, etc. The memory 630 may store software 632 which may be processor-readable, processor-executable software code containing instructions that are configured to, when executed, cause the processor 610 to perform various functions described herein. Alternatively, the software 632 may not be directly executable by the processor 610 but may be configured to cause the processor 610, e.g., when compiled and executed, to perform the functions. The network entity 600 may also or alternatively include similar components of the server 400. For example, the network entity 600 may be the TRP 300, or may be the server 400 and configured to communicate with (e.g., to send requests to) the TRP 300, or may include the TRP 300 and be configured to communicate with (e.g., to send requests to) the TRP portion of the network entity 600.

The description herein may refer to the processor 610 performing a function, but this includes other implementations such as where the processor 610 executes software (stored in the memory 630) and/or firmware. The description herein may refer to the network entity 600 performing a function as shorthand for one or more appropriate components (e.g., the processor 610 and the memory 630) of the network entity 600 performing the function. The processor 610 (possibly in conjunction with the memory 630 and, as appropriate, the interface 620) includes an angle information unit 650. The angle information unit 650 may be configured to request the TRP 300 to send reference signal angle information to the UE 500 for use by the UE 500 in measuring one or more reference signals. For example, if the network entity 600 is the TRP 300, then the angle information unit 650 may request one or more other portions of the network entity 600 to send the reference signal angle information to the UE 500. The reference signal angle information may, for example, identify one or more specific signals, may identify one or more reference signal frequency bands, may explicitly or implicitly indicate an angle of arrival window for a respective reference signal, may indicate a location corresponding to each reference signal and angle of arrival window, and/or may indicate a validity time associated with each reference signal and angle of arrival window. The configuration and functionality of the angle information unit 650 is discussed further herein, and the network entity 600 (e.g., the processor 610 and one or more other components as appropriate, such as the memory 630) is configured to perform the functions of the angle information unit 650 discussed herein.

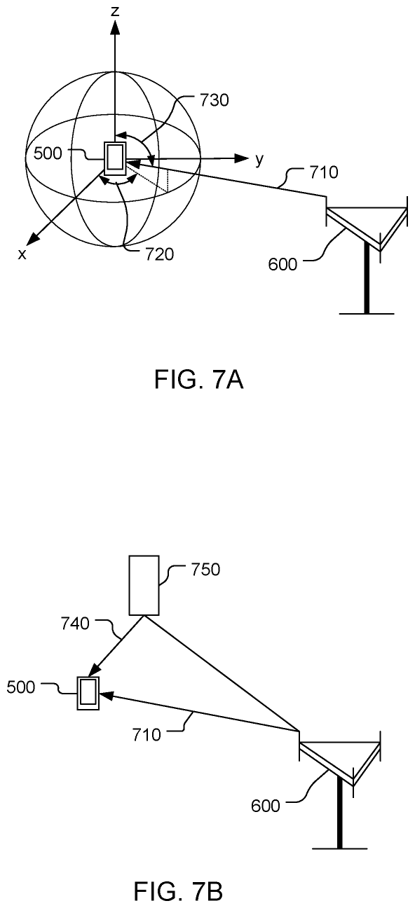

Referring to FIGS. 7A and 7B, with further reference to FIGS. 5 and 6, the network entity 600 (here shown as a TRP that may, for example, include an LMF) may send a reference signal to the UE 500. The reference signal may follow an LOS path 710 that is incident upon a location of the UE 500 at an arrival angle characterized by an azimuthal angle 720 (θ) and a zenith angle 730 (φ). The orientation of the UE 500 in FIGS. 7A and 7B is an example, as the UE 500 may be rotated to a variety, possibly any, orientation. The azimuthal angle θ and the zenith angle φ are determined relative to a surface of the Earth, assuming the Earth is a perfect sphere, the x-y plane is tangent to the sphere at the location of the UE 500, and the z-axis is normal to the x-y plane. In addition to the LOS path 710, the reference signal may also (or alternatively) follow an NLOS path 740, being emitted from the network entity 600 and reflecting off an object 750 before being received by the UE 500. The AoA of the reference signal from the NLOS path 740 (a reflected path) will typically be different from the AoA of the LOS path 710 (although AoA of the LOS path 710 and the AoA of the NLOS path 740 may be within the same range of AoAs). Although one NLOS path and one reflecting object are shown in FIG. 7B, and one reference signal is discussed as being sent from the network entity 600 to the UE 500, multiple reference signals may be sent and/or a reference signal may take multiple NLOS paths to a destination location (e.g., to the UE 500), e.g., reflecting off different objects, reflecting off multiple objects in one NLOS path, etc.

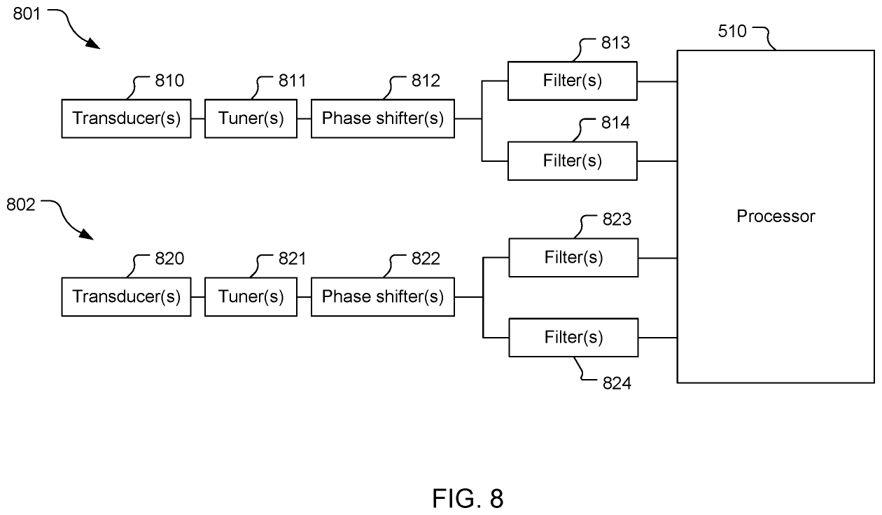

Referring also to FIG. 8, multiple receive-signal paths 801, 802 may be provided in the UE 500. One or more transducers 810, 820 may be coupled to one or more respective tuners 811, 821 that may be coupled to one or more respective phase shifters 812, 822 that may be coupled to one or more filters 813, 823 and one or more filters 814, 824 to receive one or more signals from one or more desired AoAs and to provide the signal(s) to the processor 510, e.g., for measurement. The tuner(s) 811, 821, the phase shifter(s) 812, 822, and the filter(s) 813, 814, 823, 824 are optional, and any one or more of these items may be omitted. The tuner(s) 811, the phase shifter(s) 812, and the filter(s) 813, 814 provide two of the receive-signal paths 801. The transducer(s) 810 may comprise one or more antenna panels. The tuner(s) 811 may be adjusted under the control of the processor 510 such that the transducer(s) 810 are tuned to receive different frequencies (e.g., signals of different frequency bands). The phase shifter(s) 812 may be controlled by the processor 510 to provide different phase shifts to the transducer(s) 810 to steer a beam of the transducer(s) 810. The filter(s) 813, 814 may be configured to block or allow desired signal frequencies, and may be controlled by the processor 510 to change what frequencies are blocked/passed. The transducer(s) 820, the tuner(s) 821, the phase shifter(s) 822, and the filter(s) 823, 824 are configured to provide similar functionality as the transducer(s) 810, the tuner(s) 811, the phase shifter(s) 812, and the filter(s) 813, 814. One of more of the receive-signal paths 801, 802 may be changed to receive different frequencies and/or different angles of arrival of signals at different times, e.g., by varying phase shifts and/or frequency filters applied to the received signals. The receive-signal paths 801, 802 shown are examples, and other configurations are possible.

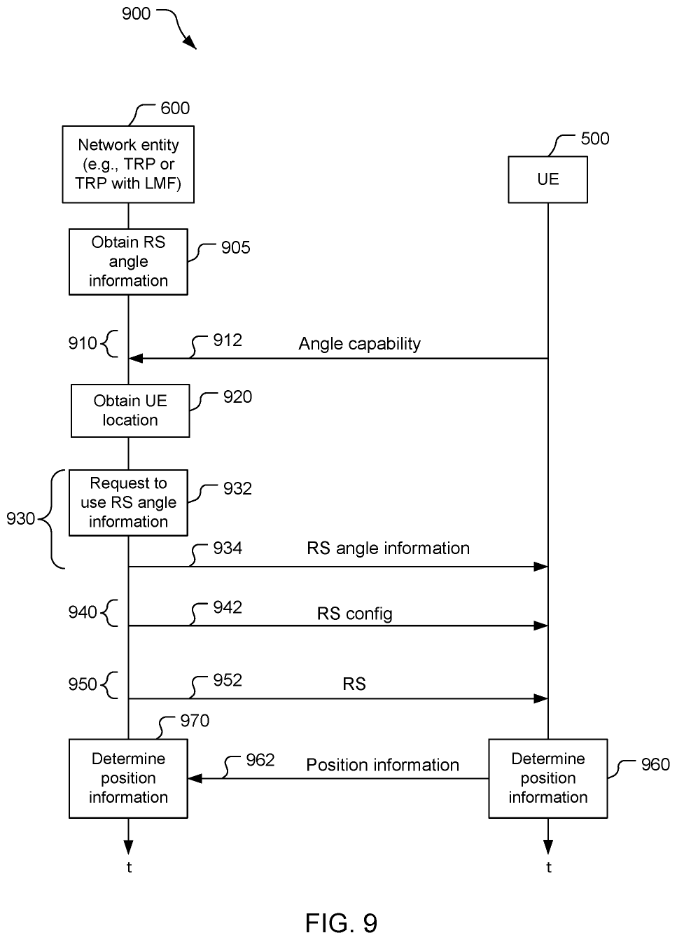

Referring also to FIG. 9, a processing and signal flow 900 for determining position information includes the stages shown. The flow 900 is an example, and stages may be added to, removed from, and/or rearranged in the flow 900.

At stage 905, the network entity 600 may obtain reference signal angle information. For example, the network entity 600 may gather crowd-sourced information by analyzing channel paths (e.g., delays, angles, path gains, etc.) across multiple signals, e.g., multiple PRS beams and/or multiple SRS beams (ports), information about location at which the information was collected, etc. The network entity 600 may analyze the information to determine angle of arrival corresponding to different signals, e.g., different reference signal channels. The information determined may include AoAs for LOS signals and for NLOS signals reflected before arriving at the corresponding locations.

At stage 910, the UE 500, e.g., the angle capability unit 550, sends an angle capability message 912, via the interface 520, to the network entity 600. The angle capability message 912 may indicate whether the UE 500 is capable of using angle information to assist in measuring reference signals, e.g., to determine AoA of a reference signal. The angle capability message 912 may include one or more parameters regarding the ability of the UE 500 to use angle information, e.g., one or more parameters regarding the ability of the UE 500 to measure angle of one or more reference signals. The angle capability message 912 may provide information regarding the ability of the UE 500 to use angle information for different frequencies (e.g., frequency bands, frequency band combinations), e.g., because the UE 500 may have different quantities and/or types of antennas, with different performance characteristics, for different frequencies. The different antenna quantities and/or types may provide different abilities to beam steer, e.g., to certain angles relative to a body of the UE 500.

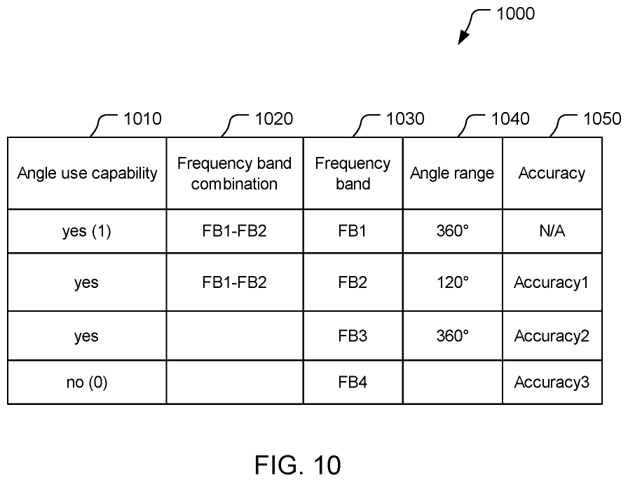

Referring also to FIG. 10, an example angle capability message 1000 includes an angle use capability field 1010, a frequency band combination field 1020, a frequency band field 1030, an angle range field 1040, and an accuracy field 1050. Values in the angle use field 1010 may indicate whether the UE 500 may use angle information (e.g., an angle search window) to measure reference signals. The values of the angle use capability field 1010 may be coded, e.g., a single bit with a value of 1 indicating that the UE 500 can use angle information and a value of 0 indicating that the UE 500 will not use angle information to measure reference signals (e.g., in corresponding frequency band combinations and/or frequency bands indicated by the fields 1020, 1030). The frequency band combination field 1020 indicates one or more frequency bands corresponding to the angle use capability indication in the angle use capability field 1010. The frequency band field 1030 indicates one or more frequency bands corresponding to the angle use capability indication in the angle use capability field 1010 and the frequency band combination(s) (if any) indicated in the frequency band combination field 1020. Thus, for example, within a frequency band combination indicated in the field 1020, a frequency band may be indicated in the field 1030 for angle use capability of the UE 500 for the indicated band within the corresponding indicated band combination. The ability of the UE 500 to use angle information, e.g., for different band combinations and/or different bands, may depend on the number of antennas and/or panels of antennas (e.g., different locations on the UE 500 of one or more antenna elements) and the performance of the antenna(s), e.g., potential scan angle(s). The angle range field 1040 may indicate an angular range or field of view (FOV) that the UE 500 may be capable of steering an antenna beam over for the corresponding band combination and/or the corresponding band. For example, a value of the angle range field 1040 may indicate a maximum sweep angle for an antenna beam corresponding to the indicated band combination in the field 1020 and/or the indicated band in the field 1030. A value of 360° in the angle range field 1040 may indicate that there is no angle sweep limit for the corresponding band combination and/or band. Values of the accuracy field 1050 may provide one or more parameters regarding the accuracy of position information (e.g., one or more measurements, one or more position estimates, etc.) to be provided by the UE 500 (e.g., required to be provided). The fields 1020, 1030, 1040, 1050 are optional and one or more of the fields 1020, 1030, 1040, 1050 may be omitted. Further, an indication that the UE 500 is not capable of using angle information may be a default, and the capability message 1000 may omit any value in the angle use capability field 1010 indicating that the UE 500 is not capable of using angle information to measure reference signals. The lack of an angle use capability may be indicated by a 0° angle range. The angle use capability field 1010 may be omitted, e.g., with the capability of the UE 500 to use angle information to measure a reference signal being implicit in the provision of a non-zero value for one or more of the fields 1020, 1030, 1040. The capability message 1000 is an example, and numerous other configurations of capability messages may be used.

Referring again to FIG. 9, at stage 920, the network entity 600 obtains a location of the UE 500. The network entity 600 may determine a coarse location of the UE 500 using one or more of a variety of techniques. For example, the network entity 600 may use a location of a serving TRP 300 as the location of the UE 500, or a cell-sector center of a serving cell, or may determine the location of the UE using E-CID, or another technique. The network entity 600 may determine the location of the UE 500 by combining locations determined using one or more techniques, e.g., using a weighted average. The network entity 600 may determine a future, predicted location for the UE 500, e.g., based on motion of the UE 500, particularly relative to the TRP 300. The velocity of the UE 500 may be used by the network entity 600 to determine the predicted location of the UE 500, and may be used (as discussed further below) to determine a validity time for assistance information provided to the UE 500.

At stage 930, the network entity 600, e.g., the angle information unit 650, may request the TRP 300 to use or send reference signal angle information. For example, at sub-stage 932, the angle information unit 650 may request the TRP 300 (e.g., a TRP portion of the network entity 600 or a separate TRP 300) to use the reference signal angle information for AoA measurements of UL PRS from the UE 500. Also or alternatively, the angle information unit 650 may request the TRP 300 to send, and the TRP 300 may send, a reference signal angle information message 934 to the UE 500. For example, the network entity 600 may send a request via the interface 620 to the TRP 300 which sends the message to the UE 500 or, if the network entity 600 includes the TRP 300 or is the TRP 300, then the angle information unit 650 requests the TRP portion of the network entity 600 to send the reference signal angle information message 934 to the UE 500. The reference signal angle information used by the network entity 600 at sub-stage 932 may be the same as or similar to the content of the reference signal angle information message 934. The reference signal angle information message 934 may include assistance information for use by the UE 500 in measuring a reference signal, e.g., to determine an angle of arrival of the measurement signal. The description herein may refer to a reference signal, but this includes one or more reference signals. The reference signal angle information message 934 may include one or more information elements (IEs) for conveying reference signal angle information such as DL-PRS expected AoA and/or AoD. The AoA may include azimuthal angle, e.g., the azimuthal angle 720, and/or zenith angle (e.g., ZoA (zenith angle of arrival)), e.g., the zenith angle 730, and the AoD may include azimuthal angle and/or zenith angle (e.g., ZoD (zenith angle of departure)). The IE(s) may include DL-PRS expected uncertainty that, combined with the expected angle, may provide a search window. Also or alternatively, endpoints of a search window may be provided, e.g., a low-end angle and a high-end angle so that the UE 500 can search between the low-end angle and the high-end angle for a reference signal. The IE(s) may include a location corresponding to each indication of the angle search window. The endpoints or the expected angle plus uncertainty provide explicit search windows. The angle search window may, however, be implicit (e.g., with an expected angle provided and an uncertainty around the expected angle being implicit). The angle uncertainty may be implicit, for example, by having the uncertainty statically and/or dynamically configured in the UE 500 and the network entity 600. The UE 500 may be statically configured (e.g., hard-coded during manufacture of the UE 500) and/or dynamically configured (e.g., by receiving an instruction with a configuration or an instruction as to which angle uncertainty to use from a set of statically-configured configurations).

The RS angle information message 934 may be sent to one or more UEs 500.

For example, UEs within an area may benefit from the same RS angle information message 934, e.g., may be able to use at least some the same angle assistance data to help narrow search windows. The network entity 600 may cause the TRP 300 (e.g., a TRP portion of the network entity 600) to broadcast the RS angle information message 934 and/or to send the RS angle information message 934 in a multi-cast message. The UEs 500 to receive the RS angle information message 934 may be grouped, e.g., with the UEs in a group assigned a common group ID and the RS angle information message 934 broadcast with the group ID, or the RS angle information message 934 may be multicast to UEs 500 with the same group ID.

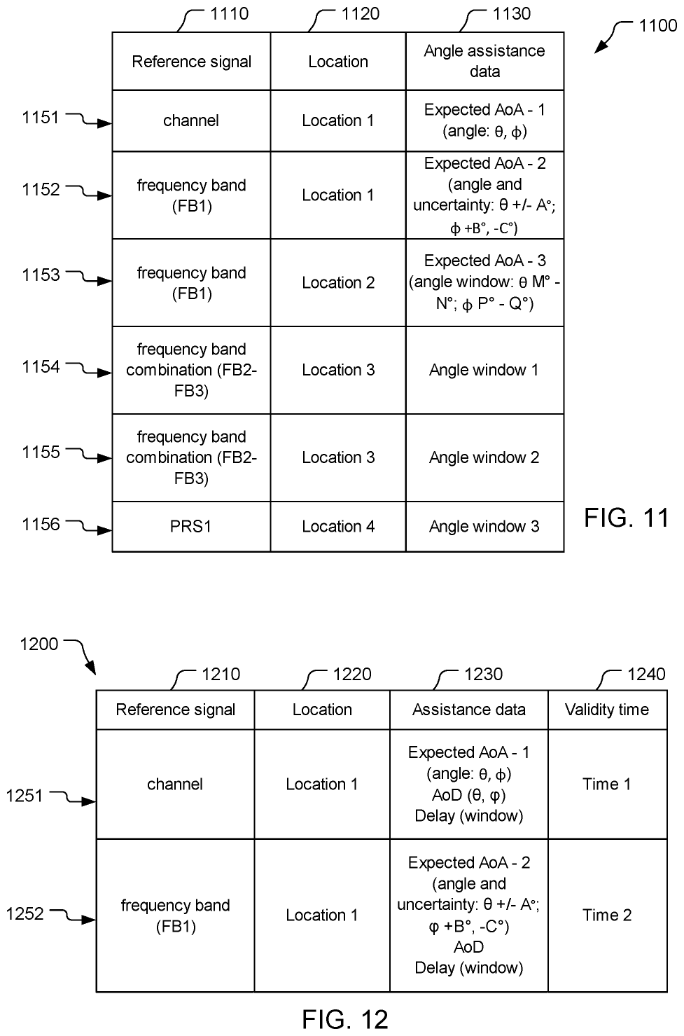

Referring also to FIG. 11, content of the reference signal angle information message 934 may be selected from a reference signal angle information table 1100 that includes a reference signal field 1110, a location field 1120, and an angle assistance data field 1130. The table 1100 includes various example values of the fields 1110, 1120, 1130, some of which have different formats for the same field. The table 1100 is an example, and other configurations of reference signal angle information messages may be used, e.g., with the same format of values of a given field being used for different, e.g., all, entries. The reference signal angle information table 1100 includes entries 1151, 1152, 1153, 1154, 1155, 1156, with each of the entries 1151-1156 including values for each of the fields 1110, 1120, 1130.

The network entity 600 may indicate the reference signal(s) to the UE 500 in a variety of manners in accordance with values taken from the table 1100. For example, as shown in the entry 1151, the reference signal field 1110 may indicate a channel. The channel indication may include one or more parameters for the channel (e.g., frequency layer) to define the reference signal. As another example, as shown in the entries 1152, 1153, the reference signal field 1110 may indicate a frequency band, such that all reference signals within the indicated frequency band will have the corresponding location and assistance data (i.e., as indicated by the other fields 1120, 1130 of the same entry). As another example, as shown by the entries 1154, 1155, the reference signal field 1110 may indicate a frequency band combination, such that all reference signals within the indicated frequency band combination will have the corresponding location and assistance data (and possibly validity time). As another example, as shown in the entry 1156, the reference signal field 1110 may indicate a specific signal, here PRS1. The specific signal indication may include one or more parameters to define the signal (e.g., frequency layer, slot offset, symbol offset, comb number, etc.).

Each of the entries 1151-1156 in the reference signal angle information table 1100 includes location for which the entry is applicable, e.g., for which the angle assistance data is applicable. The location may be a specific point (e.g., x, y, and z coordinates, or latitude and longitude, etc.), or an area (e.g., a point with a radius, or a defined boundary (e.g., a rectangle, a circle, or other regular shape, or an irregular shape)).

The angle assistance data field 1130 of each of the entries 1151-1156 provides angle information that the UE 500 and/or the TRP 300 may use to measure one or more signals, e.g., reference signals. For example, the angle information may provide a specific angle (e.g., a mean or expected angle of arrival of a (reference) signal), e.g., as shown in the entry 1151. The angle may include an azimuthal angle (θ) and may also include a zenith angle (φ). As another example, the angle information may include a search window in the form of an expected angle and an uncertainty, e.g., as shown in the entry 1152. The uncertainty may be specified by a signal uncertainty value and thus be symmetrical about the expected angle, e.g., +/−A°, or may be specified by a lower uncertainty and an upper uncertainty, e.g., +B°, −C° such that the uncertainty may be asymmetrical about the expected angle. As another example, the angle information may provide a search window by specifying bounds of the search window. As shown in the entry 1153, the angle assistance data specifies a window with an azimuthal angle range from M° to N° and a zenith angle range from P° to Q°. Angle window values are generically indicated as angle window 1, angle window 2, and angle window 3 in the entries 1154-1156, respectively.

The angles in the angle assistance data 1130 may include angles of arrival at UE locations and/or at TRP locations. The angle assistance data may provide expected angles of arrival of reference signals at prospective UE locations. The processor 610 or the processor 310 may use these angles to determine corresponding angles of arrival of reference signals from the corresponding locations at the TRP 300 (e.g., separate from or part of the network entity 600). Also or alternatively, the angle assistance data 1130 may comprise expected angles of arrival at one or more TRPs of references signals sent from prospective locations by the UE 500. A TRP 300, e.g., of the network entity 600, may use the angle assistance data 1130 to narrow an angular search window for UL PRS from the UE 500, e.g., for AoA-based positioning.

The network entity 600 is configured to obtain values for the reference signal angle information table 1100. For example, the network entity 600 may obtain the reference signal angle information as discussed above with respect to stage 905. The network entity 600 may determine angle of arrival corresponding to different signals, e.g., different reference signal channels, to produce the table 1100 from which the network entity 600 may select information for the reference signal angle information message 934.

The network entity 600 may be configured to produce or to request the TRP 300 to produce the reference signal angle information message 934 only if the network entity 600 receives the angle capability message 912 indicating that the UE 500 is capable of using angle information for measuring at least one reference signal. For example, the network entity 600 may produce the message 934 and/or request the TRP 300 to produce the message 934 in response to receiving the angle capability message 912, and in response to the angle capability message 912 indicating that the UE 500 can use angle information for at least one reference signal to receive and/or measure the reference signal(s). The network entity 600 may be configured to produce, or request production of, the message 934 in response to the UE 500 indicating that the UE 500 may use angle information for at least one reference signal that the TRP 300 will be transmitting.

Referring also to FIG. 12, the network entity 600 may select reference signal angle information to be used by the network entity at sub-stage 932 and/or for use in the reference signal angle information message 934. For example, the network entity 600 may request the TRP 300 to produce the reference signal angle information message 934, e.g., a message 1200, by selecting information from the table 1100, and possibly providing additional information, for entries in the message 1200, here entries 1251, 1252. The message 1200 is an example of the message 934 (or the reference signal angle information used at sub-stage 932) and includes a reference signal field 1210, a location field 1220, an assistance data field 1230, and a validity time field 1240. The fields 1210, 1220, and at least a portion of the field 1230, may be populated with information selected from the table 1100. For example, the network entity 600, e.g., the angle information unit 650, may use the determined (e.g., predicted) location of the UE 500 to identify one or more entries in the table 1100 whose locations include the determined location of the UE 500. Alternatively, the network entity 600 may provide assistance data relevant to one or more locations in addition to, and/or other than, the predicted location of the UE 500 (e.g., providing assistance data for a region around the UE 500). The network entity 600 may determine which reference signals, corresponding to the identified entry(ies), the TRP 300 will be transmitting, and for which the UE 500 may use angle information (based on the angle capability message 912), and produce one or more entries for the message 1200 that include the reference signal(s) to be transmitted for which the UE 500 may use angle information, and the corresponding location(s). Alternatively, the message 1200 may include one location indication that indicates a region in which the angle assistance data may (or should) be used. The angle information unit 650 may populate the assistance data field 1230 with angle assistance data from the identified entry(ies) from the table 1100. The angle information unit 650 may include AoD information in the assistance data field 1230 in addition to or instead of AoA information. The AoD information may indicate an angle of departure of the respective reference signal, which the UE 500 may use for RF sensing and/or positioning using multipath. For example, the UE 500 may use the AoD of a measured signal to help determine a location of a reflecting object and/or to help determine the location of the UE 500 using the reflected signal.

One or more values of the assistance data field 1230 may depend on one or more parameters (e.g., quality, latency, and/or accuracy) of position information to be provided by the UE 500. For example, a smaller angle window may be provided the smaller the latency requirement. As another example, the assistance data may be provided in response to a threshold level of accuracy being required, and the assistance data not provided otherwise, e.g., if only a coarse location of the UE 500 is requested.

The assistance data field 1230 may include delay assistance data in addition to angle assistance data. The network entity 600 may request the TRP 300 to provide timing information so that the UE 500 may narrow a time search window for the reference signal to be measured in addition to the angle information to help the UE 500 narrow the AoA search window for the reference signal to be measured. Similar to the angle information, the timing information may be provided as beginning and ending times for the window, as a reference point in time and a time uncertainty (symmetrical or asymmetrical) to determine the window, as a reference time with an implicit uncertainty, etc. The timing information may be provided jointly with the angle information, as shown, or may be provided independently of the angle information and the UE 500 (e.g., the processor 510) may analyze corresponding information (e.g., location, reference signal) for the angle and timing information to use both the angle and timing information jointly, e.g., to search for and measure a reference signal. The discussion herein, while often referring to reference signals, may be applicable to signals other than reference signals.

The validity time field 1240 of each of the entries 1251, 1252 provides a validity time for the assistance data field 1230. The angle information may change rapidly, e.g., due to movement of the UE 500 relative to the TRP 300. Also, the angle information may be very base-station specific, varying significantly from base station to base station (e.g., due to different relative motion of the UE 500 to different base stations, e.g., relative to LOS paths from the UE 500 to the different base stations). For example, if the UE 500 is moving substantially directly toward or substantially directly away from the TRP 300, then the angle information may not change much if at all for LOS signals, but if the UE 500 is moving partially or substantially transverse to an LOS with the TRP 300, then the angle information may change quickly, especially the closer the UE 500 is to the TRP 300. Consequently, the network entity 600 may request the TRP 300 to include a validity time value for the message 1200 or for each entry of the message 1200. Different entries of the message 1200 may include different validity times because the angle information may change at different rates for different reference signals, e.g., due to different paths, especially different NLOS paths. The validity time values, e.g., Time 1 in the entry 1251, and Time 2 in the entry 1252, indicate a valid time for the corresponding assistance data in the assistance data field 1230 (at least the angle information in the assistance data field 1230). The validity time may be specified in a variety of manners, e.g., a timer value for a time after receipt of the message 1200, or a specific time in the future (e.g., time of day). The validity time indicates a time after which the UE 500 (or the network entity 600 at sub-stage 932) should not use the corresponding assistance data, or at least after which the assistance data may not be helpful in narrowing an angle and/or time search for a reference signal. The value(s) of the validity time(s) may depend on a rate of change of the expected AoA of a (reference) signal. The value(s) of the validity time(s) may depend on a variety of factors including distance between the UE 500 and the TRP 300, speed of the UE 500, direction of movement of the UE 500 relative to the TRP 300 (e.g., relative to an LOS path between the UE 500 and the TRP 300, and thus a rate of AoA change of the LOS path), etc. For example, if the UE 500 is close to the TRP 300 and/or moving quickly transverse to the LOS path, then the validity time may be much shorter than if the UE 500 is stationary, moving slowly, and/or moving close to the LOS path.

The assistance data may be updated repeatedly. For example, in order to accommodate the rapid changing of angle assistance information, the network entity 600 may request the TRP 300 to send the RS angle information message 934 repeatedly, frequently, and quickly. The RS angle information message 934 may be sent to the UE 500 with updated information periodically and/or aperiodically (e.g., on demand). The RS angle information message 934 may, for example, be sent to the UE 500 using lower-layer (low-latency) communication, e.g., MAC-CE (Medium Access Control-Control Element), especially if the network entity 600 includes an LMF (a local LMF in the RAN). An updated RS angle information message may, for example, be provided before expiration of the validity time of the RS angle information message 934 (e.g., a most-recently-sent RS angle information message, or at least the most-recently-sent RS angle information message that contained assistance information for a reference signal of the updated RS angle information message).

At stage 940, the TRP 300 sends an RS configuration message 942 to the UE 500. The RS configuration message 942 contains one or more parameters of an RS configuration, e.g., a DCI message with slot offset, comb number, frequency offset, frequency layer, etc. The UE 500 uses the RS configuration information to help measure a reference signal, e.g., by tuning one or more antennas appropriately, and uses the assistance data to narrow a search direction and/or search time for the reference signal.

At stage 950, the TRP 300 sends one or more RS 952 to the UE 500. The TRP 300 sends RS based on the RS configuration message 942, e.g., with the indicated parameter(s), and possibly in a direction indicated by the AoD information in the assistance data.

At stage 960, the UE 500 determines position information based on received RS. For example, the UE 500 may measure PRS from the TRP 300 to determine position information (e.g., RSRP, ToA, SINR, a position estimate, etc.). The UE 500 may send some or all of the determined position information to the network entity 600 (e.g., the TRP 300 or the server 400 via the TRP 300) in a position information message 962. The UE 500 may be configured (dynamically or statically) to report (e.g., in response to receiving an indicated angle measurement window) only measurements of reference signals that were measured within the indicated angle window. For example, for RF sensing, this may be beneficial by narrowing a list of targets. Also or alternatively, the UE 500 may be configured (dynamically or statically) to report measurements of reference signals that were measured within the indicated angle window and measurements of reference signals that were measured outside the indicated angle window. The UE 500 may be configured to indicate that a reference signal, for which an angle window was provided, was received outside of the indicated angle window. The UE 500 may be configured to indicate that the provided assistance data were invalid and/or incorrect. Also or alternatively, the UE 500 may be configured to provide feedback to the network entity 600 to help the network entity 600 determine assistance data. For example, the UE 500 may be configured to provide suggested assistance data to the network entity 600 based on an AoA of a received reference signal. The suggested assistance data may be, for example, the actual AoA of the received reference signal and/or an angle search window that includes the actual AoA of the received reference signal. For example, the message 962 may indicate that a channel X reference signal was received with an azimuthal AoA of Y° (and possibly indicate that the reference signal was received with a zenith AoA of Z°).

At stage 970, the network entity 600 may determine position information. The network entity 600 (e.g., an LMF) may, for example, determine a range and/or a position estimate of the UE 500 based on the position information message 962, and possibly based on one or more other messages with other measurement information.

Operation

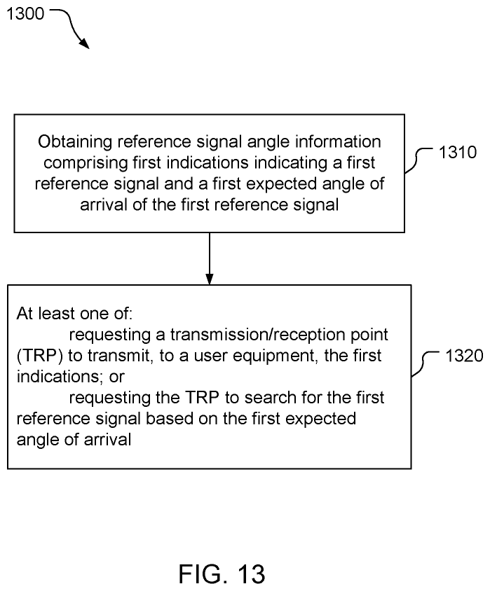

Referring to FIG. 13, with further reference to FIGS. 1-12, a signal measurement assistance method 1300 includes the stages shown. The method 1300 is, however, an example only and not limiting. The method 1300 may be altered, e.g., by having stages added, removed, rearranged, combined, performed concurrently, and/or having single stages split into multiple stages.

At stage 1310, the method 1300 includes obtaining reference signal angle information comprising first indications indicating a first reference signal and a first expected angle of arrival of the first reference signal. For example, the angle information unit 650 may retrieve reference signal angle information including one or more indications of one or more reference signals and corresponding angle assistance data from the table 1100 stored in the memory 630 (e.g., per the message 1200), or receive such information via the interface 620 (e.g., collecting crowd-sourced information). The processor 610, possibly in combination with the memory 630, possibly in combination with the interface 620 (e.g., the wireless receiver 344 and the antenna 346, the wired receiver 354, the wireless receiver 444 and the antenna 446, and/or the wired receiver 454) may comprise means for obtaining reference signal angle information.

At stage 1320, the method 1300 includes at least one of: requesting a transmission/reception point (TRP) to transmit, to a user equipment, the first indications; or requesting the TRP to search for the first reference signal based on the first expected angle of arrival. For example, the angle information unit 650 may request the interface 620 to send to the TRP (that is part of the network entity 600), or to send a request to a separate TRP 300 via the interface 620 (e.g., the wired transmitter 452) for the TRP 300 to send, the first indications (e.g., values of at least portions the reference signal 1110 and the assistance data 1130 or values of at least portions of the fields 1210, 1230 of the message 1200). The processor 610, possibly in combination with the memory 630, possibly in combination with the interface 620 (e.g., the wireless transmitter 442 and the antenna 446, and/or the wired transmitter 452) may comprise means for requesting the TRP to send the first indications. Also or alternatively, the angle information unit 650 may request the TRP 300 (e.g., a TRP portion of the network entity 600) to search for one or more reference signals based on one or more expected angles of arrival of the one or more reference signals. For example, the angle information unit 650 may use values of at least portions the reference signal 1110 and the assistance data 1130 (e.g., values of at least portions of the fields 1210, 1230 of the message 1200 (regardless of whether the message 1200 is produced)) to establish one or more search windows for the one or more reference signals. The processor 610, possibly in combination with the memory 630, may comprise means for requesting the TRP to search for the first reference signal based on the first expected angle of arrival.

Implementations of the method 1300 may include one or more of the following features. In an example implementation, the method 1300 includes at least one of: requesting the TRP to transmit, to the user equipment, a validity time indication associated with the first indications; or providing the validity time indication to the TRP. For example, with the network entity 600 being or including the TRP 300, the angle information unit 650 may cause the interface (e.g., the wireless transmitter 342 and the antenna 346) to send the validity time field 1240 in the message 1200. As another example, with the network entity being the server 400, the angle information unit 650 may send a request to the TRP 300 via the interface 620 (e.g., the wired transmitter 452) for the TRP to send the validity time indication. As another example, with the network entity 600 including the TRP 300, the angle information unit 650 may provide the validity time indication to the TRP 300. The processor 610, possibly in combination with the memory 630, possibly in combination with the interface 620, may comprise means for requesting the TRP to transmit the validity time indication and/or means for providing the validity time indication to the TRP. In another example implementation, the method 1300 includes determining a value of the validity time indication based on motion of the user equipment relative to the TRP. For example, the processor 610 may calculate the validity time indication or select the validity time indication from a set of predefined validity time value options. The processor 610 may determine the value of the validity time based, for example, on an expected rate of change of an expected AoA of an LOS path between the TRP 300 and the UE 500, e.g., based on speed and direction of the UE 500 (e.g., angular speed relative to the TRP 300). As another example, the processor 610 may determine the value of the validity time based on speed of the UE 500, e.g., without determining a rate of change of an AoA at the UE 500. The processor 610, possibly in combination with the memory 630, possibly in combination with the interface 620 (e.g., to obtain UE motion information), may comprise means for determining a value of the validity time indication.

Also or alternatively, implementations of the method 1300 may include one or more of the following features. In an example implementation, the first indications further indicate a first location, and the reference signal angle information further comprises second indications indicating the first reference signal, a second expected angle of arrival of the first reference signal, and a second location, and the method further comprises: obtaining a user-equipment location of the user equipment; and selecting the first indications from the reference signal angle information based on the user-equipment location corresponding to the first location. For example, the first indications may also include an indication of the location field 1120, the processor 610 may obtain (e.g., calculate or receive) a location (present or future (e.g., predicted)) of the UE 500 and may select the first indications corresponding to the location of the UE 500 (e.g., containing the location of the UE 500) from multiple possible sets (e.g., table entries) of such indications, e.g., stored in a table such as the table 1100. The processor 610, possibly in combination with the memory 630, possibly in combination with the interface 620 (e.g., the wireless receiver 344 and the antenna 346, the wireless receiver 444 and the antenna 446, and/or the wired receiver 454) may comprise means for obtaining the user-equipment location. The processor 610, possibly in combination with the memory 630, may comprise means for selecting the first indications. In another example implementation, the method 1300 comprises requesting the TRP to transmit the first indications to the user equipment as one of a MAC-layer message or a physical-layer message. For example, the network entity 600 may repeatedly obtain locations of the UE 500, determine RS angle information messages 934 based on the locations, and send the RS angle information messages 934 to the UE 500, e.g., using a low-latency communication such as a MAC-CE or physical-layer messaging.

Also or alternatively, implementations of the method 1300 may include one or more of the following features. In an example implementation, the first indications indicate the first expected angle of arrival of the first reference signal as a first angle search window including the first expected angle of arrival of the first reference signal. For example, the RS angle information message 934 may include an angle search window (e.g., the expected AoA and an uncertainty, or beginning an end angles that span the expected AoA), e.g., as shown in the entries 1151-1153. The AoA may include azimuthal angle and possible zenith angle. In another example implementation, the reference signal angle information further comprises second indications indicating the first reference signal and a second expected angle of arrival of the first reference signal, the first expected angle of arrival is different from the second expected angle of arrival, and at least one of the first expected angle of arrival and the second expected angle of arrival corresponds to a non-line-of-sight path between the TRP and the user equipment. For example, multiple indications of a reference signal with multiple corresponding expected AoAs may be provided in the RS angle information (e.g., the RS angle information message 934) with at least one NLOS expected AoA included in the RS angle information. In another example implementation, obtaining the reference signal angle information comprises analyzing reference signal measurements and locations corresponding to the reference signal measurements. For example, the processor 610 may compile reference signal angle information for use as assistance data from crowd-sourced measurements of reference signals. The processor 610, possibly in combination with the memory 630, may comprise means for analyzing reference signal measurements and locations. In another example implementation, the method 1300 comprises requesting the TRP to transmit the first indications to the user equipment in response to receiving, from the user equipment, a capability message indicating that the user equipment is configured to use angle-of-arrival information to measure reference signals. For example, the processor 610 may request the interface 620, or a separate TRP 300, to send angle assistance information in response to the UE 500 reporting (possibly only if the UE 500 reports) a capability to use the angle assistance information to receive (and measure) reference signals. In another example implementation, the user equipment is a first user equipment, and the method comprises requesting the TRP to transmit, in at least one of a multicast message or a broadcast message, the first indications to both the first user equipment and a second user equipment. For example, angle information unit 650 may request a separate TRP 300 or a TRP 300 that is part of the network entity 600, to send a multicast or broadcast message with the first indications to multiple UEs 500, e.g., for use in reducing angle search windows for measuring one or more reference signals. The processor 610, possibly in combination with the memory 630, possibly in combination with the interface 620 (e.g., the wireless transmitter 442 and the antenna 446, or the wired transmitter 452) may comprise means for requesting the TRP to transmit a multicast message and/or a broadcast message.

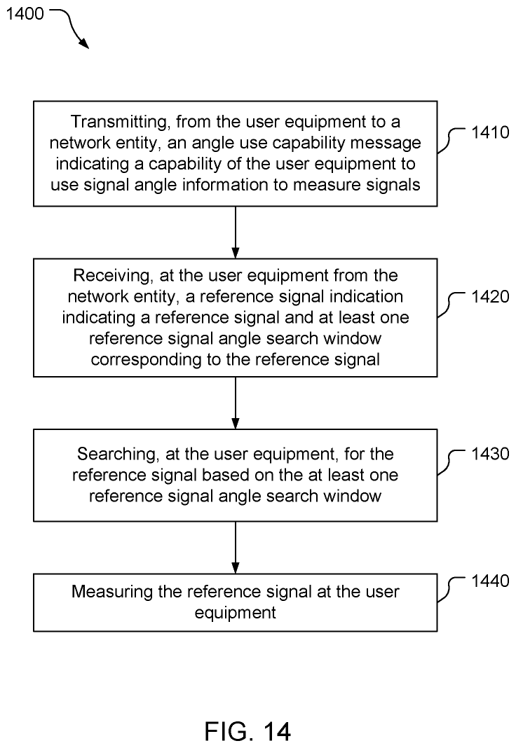

Referring to FIG. 14, with further reference to FIGS. 1-12, a method 1400 measuring a reference signal at a user equipment includes the stages shown. The method 1400 is, however, an example only and not limiting. The method 1400 may be altered, e.g., by having stages added, removed, rearranged, combined, performed concurrently, and/or having single stages split into multiple stages.

At stage 1410, the method 1400 includes transmitting, from the user equipment to a network entity, an angle use capability message indicating a capability of the user equipment to use signal angle information to measure signals. For example, the UE 500, e.g., the angle capability unit 550, may send the angle capability message 912, e.g., one or more entries of the message 1000 or similar message, to the network entity 600 via the interface 520. The processor 510, possibly in combination with the memory 530, in combination with the interface 520 (e.g., the wireless transmitter 242 and the antenna 246) may comprise means for transmitting the angle use capability message.

At stage 1420, the method 1400 includes receiving, at the user equipment from the network entity, a reference signal indication indicating a reference signal and at least one reference signal angle search window corresponding to the reference signal. For example, the UE 500 may receive the RS angle information message 934 from the network entity 600 (which may be the same entity to which the UE 500 sent the angle capability message 912 or may be a different entity). The message 934 may indicate one or more parameters (e.g., frequency and/or channel) indicative of the reference signal. The reference signal angle search window may be implicit (e.g., based on an expected AoA provided and a pre-coded uncertainty) or explicit. The processor 510, possibly in combination with the memory 530, in combination with the interface 520 (e.g., the wireless receiver 244 and the antenna 246) may comprise means for receiving the reference signal indication.

At stage 1430, the method 1400 includes searching, at the user equipment, for the reference signal based on the at least one reference signal angle search window. For example, the processor 510 may control the interface 520, e.g., one or more antenna panels or one or more antennas. For example, the processor 510 may control one or more components of one or more of the receive-signal paths 801, 802, e.g., the transducer(s) 810, the tuner(s) 821, the phase shifter(s) 812, and/or the filter(s) 813, 814, 823, 824 to search for a reference signal based on the reference signal angle search window, e.g., to search across the AoAs of the search window. The processor 510, possibly in combination with the memory 530, in combination with the interface 520 (e.g., the wireless receiver 244 and the antenna 246, including one or more of the receive-signal paths 801, 802) may comprise means for searching for the reference signal.

At stage 1440, the method 1400 includes measuring the reference signal at the user equipment. For example, the processor 510 may measure one or more parameters (e.g., RSRP, RSSI, ToA, etc.) of the reference signal received by searching (e.g., as discussed herein) for the reference signal. The processor 510, possibly in combination with the memory 530, in combination with the interface 520 520 (e.g., the wireless receiver 244 and the antenna 246) may comprise means for searching for the reference signal.

Implementations of the method 1400 may include one or more of the following features. In an example implementation, the method 1400 includes reporting measurements of the reference signal only if the reference signal is received within the at least one reference signal angle search window. For example, the processor 510 may be configured not to report (and possible not to measure) any reference signal received outside of an indicated angle search window. The processor 510, possibly in combination with the memory 530, in combination with the interface 520 (e.g., the wireless transmitter 242 and the antenna 246) may comprise means for reporting measurements of the reference signal. In another example implementation, the method 1400 includes reporting measurements of the reference signal regardless of whether the reference signal is received outside the at least one reference signal angle search window. For example, the processor 510 may be configured to report measurements of a reference signal received inside or outside of an indicated angle search window. In another example implementation, the method 1400 includes transmitting, from the user equipment to the network entity, an error message indicating that the user equipment failed to receive the reference signal within the at least one reference signal angle search window. For example, the processor 510 may be configured to send, via the interface 520, an indication that the reference signal did not arrive in the indicated angle search window. The processor 510 may send the error message to the same entity that provided the search window and/or to another entity. The error message may include the actual arrival angle at which the reference signal was received by the UE 500. The processor 510, possibly in combination with the memory 530, in combination with the interface 520 (e.g., the wireless transmitter 242 and the antenna 246) may comprise means for transmitting the error message.

Also or alternatively, implementations of the method 1400 may include one or more of the following features. In an example implementation, the angle use capability message indicates at least one of: a frequency band for which the capability of the user equipment to use the signal angle information to measure signals is applicable; or a frequency band combination for which the capability of the user equipment to use the signal angle information to measure signals is applicable. For example, the angle capability unit 550 may produce the angle capability message 912 to indicate, on a per band and/or per band combination basis, an ability of the UE 500 to use angle information for searching for a reference signal. In another example implementation, the method 1400 includes determining, at the user equipment, whether a validity time of the reference signal indication has expired, and searching for the reference signal based on the at least one reference signal angle search window is performed based on lack of expiration of the validity time of the reference signal indication. For example, the RS angle information message 934 may include one or more validity times and the processor 510 may determine whether the validity time corresponding to a reference signal to be measured has expired, and only use the angle assistance data of the RS angle information message 934 for that reference signal if the validity time for that reference signal has not expired. The processor 510, possibly in combination with the memory 530, may comprise means for determining whether the validity time of the reference signal has expired.

### IMPLEMENTATION EXAMPLES

Implementation examples are provided in the following numbered clauses.

Clause 1. A network entity comprising:

an interface;

a memory; and

a processor communicatively coupled to the interface and the memory and configured to:
obtain reference signal angle information comprising first indications indicating a first reference signal and a first expected angle of arrival of the first reference signal; and
at least one of:
   request a transmission/reception point (TRP) to transmit, to a user equipment, the first indications; or
   request the TRP to search for the first reference signal based on the first expected angle of arrival.

Clause 2. The network entity of clause 1, wherein the processor is configured to at least one of: request the TRP to transmit, to the user equipment, a validity time indication associated with the first indications; or provide the validity time indication to the TRP.

Clause 3. The network entity of clause 2, wherein the processor is configured to determine a value of the validity time indication based on motion of the user equipment relative to the TRP.

Clause 4. The network entity of clause 1, wherein the first indications further indicate a first location, and wherein the reference signal angle information further comprises second indications indicating the first reference signal, a second expected angle of arrival of the first reference signal, and a second location, and wherein the processor is configured to:

obtain a user-equipment location of the user equipment; and

select the first indications from the reference signal angle information based on the user-equipment location corresponding to the first location.

Clause 5. The network entity of clause 4, wherein the processor is configured to request the TRP to transmit, to the user equipment, the first indications as one of a MAC-layer message or a physical-layer message.

Clause 6. The network entity of clause 1, wherein the first indications indicate the first expected angle of arrival of the first reference signal as a first angle search window including the first expected angle of arrival of the first reference signal.

Clause 7. The network entity of clause 6, wherein the reference signal angle information further comprises second indications indicating the first reference signal and a second expected angle of arrival of the first reference signal, wherein the first expected angle of arrival is different from the second expected angle of arrival, and wherein at least one of the first expected angle of arrival and the second expected angle of arrival corresponds to a non-line-of-sight path between the TRP and the user equipment.

Clause 8. The network entity of clause 1, wherein the processor is configured to analyze reference signal measurements and locations corresponding to the reference signal measurements in order to obtain the reference signal angle information.

Clause 9. The network entity of clause 1, wherein the processor is configured to request the TRP to transmit the first indications to the user equipment, and wherein the processor is configured to request the TRP to transmit the first indications to the user equipment in response to receiving, from the user equipment, a capability message indicating that the user equipment is configured to use angle-of-arrival information to measure reference signals.

Clause 10. The network entity of clause 1, wherein the user equipment is a first user equipment, and wherein the processor is configured to request the TRP to transmit, in at least one of a multicast message or a broadcast message, the first indications to both the first user equipment and a second user equipment.

Clause 11. A network entity comprising:

means for obtaining reference signal angle information comprising first indications indicating a first reference signal and a first expected angle of arrival of the first reference signal; and

at least one of:
means for requesting a transmission/reception point (TRP) to transmit, to a user equipment, the first indications; or
means for requesting the TRP to search for the first reference signal based on the first expected angle of arrival.

Clause 12. The network entity of clause 11, further comprising at least one of: means for requesting the TRP to transmit, to the user equipment, a validity time indication associated with the first indications; or means for providing the validity time indication to the TRP.

Clause 13. The network entity of clause 12, further comprising means for determining a value of the validity time indication based on motion of the user equipment relative to the TRP.

Clause 14. The network entity of clause 11, wherein the first indications further indicate a first location, and wherein the reference signal angle information further comprises second indications indicating the first reference signal, a second expected angle of arrival of the first reference signal, and a second location, the network entity further comprising:

means for obtaining a user-equipment location of the user equipment; and

means for selecting the first indications from the reference signal angle information based on the user-equipment location corresponding to the first location.

Clause 15. The network entity of clause 14, wherein the network entity comprises the means for requesting the TRP to transmit the first indications to the user equipment, wherein the means for requesting the TRP to transmit the first indications comprise means for requesting the TRP to transmit the first indications as one of a MAC-layer message or a physical-layer message.

Clause 16. The network entity of clause 11, wherein the first indications indicate the first expected angle of arrival of the first reference signal as a first angle search window including the first expected angle of arrival of the first reference signal.

Clause 17. The network entity of clause 16, wherein the reference signal angle information further comprises second indications indicating the first reference signal and a second expected angle of arrival of the first reference signal, wherein the first expected angle of arrival is different from the second expected angle of arrival, and wherein at least one of the first expected angle of arrival and the second expected angle of arrival corresponds to a non-line-of-sight path between the TRP and the user equipment.

Clause 18. The network entity of clause 11, wherein the means for obtaining the reference signal angle information comprise means for analyzing reference signal measurements and locations corresponding to the reference signal measurements in order to obtain the reference signal angle information.

Clause 19. The network entity of clause 11, wherein the network entity comprises the means for requesting the TRP to transmit the first indications to the user equipment, and wherein the means for requesting the TRP to transmit the first indications to the user equipment comprise means for requesting the TRP to transmit the first indications to the user equipment in response to receiving, from the user equipment, a capability message indicating that the user equipment is configured to use angle-of-arrival information to measure reference signals.

Clause 20. The network entity of clause 11, wherein the network entity comprises the means for requesting the TRP to transmit the first indications to the user equipment, wherein the user equipment is a first user equipment, and wherein the means for requesting the TRP to transmit the first indications to the user equipment comprise means for requesting the TRP to transmit, in at least one of a multicast message or a broadcast message, the first indications to both the first user equipment and a second user equipment.

Clause 21. A signal measurement assistance method comprising:

obtaining reference signal angle information comprising first indications indicating a first reference signal and a first expected angle of arrival of the first reference signal; and

at least one of:
requesting a transmission/reception point (TRP) to transmit, to a user equipment, the first indications; or
requesting the TRP to search for the first reference signal based on the first expected angle of arrival.

Clause 22. The signal measurement assistance method of clause 21, further comprising at least one of: requesting the TRP to transmit, to the user equipment, a validity time indication associated with the first indications; or providing the validity time indication to the TRP.

Clause 23. The signal measurement assistance method of clause 22, further comprising determining a value of the validity time indication based on motion of the user equipment relative to the TRP.

Clause 24. The signal measurement assistance method of clause 21, wherein the first indications further indicate a first location, and wherein the reference signal angle information further comprises second indications indicating the first reference signal, a second expected angle of arrival of the first reference signal, and a second location, the signal measurement assistance method further comprising:

obtaining a user-equipment location of the user equipment; and

selecting the first indications from the reference signal angle information based on the user-equipment location corresponding to the first location.

Clause 25. The signal measurement assistance method of clause 24, wherein the signal measurement assistance method comprises requesting the TRP to transmit the first indications to the user equipment as one of a MAC-layer message or a physical-layer message.

Clause 26. The signal measurement assistance method of clause 21, wherein the first indications indicate the first expected angle of arrival of the first reference signal as a first angle search window including the first expected angle of arrival of the first reference signal.

Clause 27. The signal measurement assistance method of clause 26, wherein the reference signal angle information further comprises second indications indicating the first reference signal and a second expected angle of arrival of the first reference signal, wherein the first expected angle of arrival is different from the second expected angle of arrival, and wherein at least one of the first expected angle of arrival and the second expected angle of arrival corresponds to a non-line-of-sight path between the TRP and the user equipment.

Clause 28. The signal measurement assistance method of clause 21, wherein obtaining the reference signal angle information comprises analyzing reference signal measurements and locations corresponding to the reference signal measurements.

Clause 29. The signal measurement assistance method of clause 21, wherein the signal measurement assistance method comprises requesting the TRP to transmit the first indications to the user equipment in response to receiving, from the user equipment, a capability message indicating that the user equipment is configured to use angle-of-arrival information to measure reference signals.

Clause 30. The signal measurement assistance method of clause 21, wherein the user equipment is a first user equipment, and wherein the signal measurement assistance method comprises requesting the TRP to transmit, in at least one of a multicast message or a broadcast message, the first indications to both the first user equipment and a second user equipment.

Clause 31. A non-transitory, processor-readable storage medium comprising processor-readable instructions configured to cause a processor of a network entity, in order to assist signal measurement, to:

obtain reference signal angle information comprising first indications indicating a first reference signal and a first expected angle of arrival of the first reference signal; and

at least one of:
request a transmission/reception point (TRP) to transmit, to a user equipment, the first indications; or
request the TRP to search for the first reference signal based on the first expected angle of arrival.

Clause 32. The storage medium of clause 31, further comprising at least one of: processor-readable instructions configured to cause the processor to request the TRP to transmit, to the user equipment, a validity time indication associated with the first indications; or processor-readable instructions configured to cause the processor to provide the validity time indication to the TRP.

Clause 33. The storage medium of clause 32, further comprising processor-readable instructions configured to cause the processor to determine a value of the validity time indication based on motion of the user equipment relative to the TRP.

Clause 34. The storage medium of clause 31, wherein the first indications further indicate a first location, and wherein the reference signal angle information further comprises second indications indicating the first reference signal, a second expected angle of arrival of the first reference signal, and a second location, the storage medium further comprising processor-readable instructions configured to cause the processor to:

obtain a user-equipment location of the user equipment; and

select the first indications from the reference signal angle information based on the user-equipment location corresponding to the first location.

Clause 35. The storage medium of clause 34, wherein the storage medium comprises processor-readable instructions configured to cause the processor to request the TRP to transmit the first indications to the user equipment as one of a MAC-layer message or a physical-layer message.

Clause 36. The storage medium of clause 31, wherein the first indications indicate the first expected angle of arrival of the first reference signal as a first angle search window including the first expected angle of arrival of the first reference signal.

Clause 37. The storage medium of clause 36, wherein the reference signal angle information further comprises second indications indicating the first reference signal and a second expected angle of arrival of the first reference signal, wherein the first expected angle of arrival is different from the second expected angle of arrival, and wherein at least one of the first expected angle of arrival and the second expected angle of arrival corresponds to a non-line-of-sight path between the TRP and the user equipment.

Clause 38. The storage medium of clause 31, wherein the processor-readable instructions configured to cause the processor to obtain the reference signal angle information comprise processor-readable instructions first angle search window configured to cause the processor to analyze reference signal measurements and locations corresponding to the reference signal measurements.

Clause 39. The storage medium of clause 31, wherein the storage medium comprises processor-readable instructions configured to cause the processor to request the TRP to transmit the first indications to the user equipment in response to receiving, from the user equipment, a capability message indicating that the user equipment is configured to use angle-of-arrival information to measure reference signals.

Clause 40. The storage medium of clause 31, wherein the user equipment is a first user equipment, and wherein the storage medium comprises processor-readable instructions configured to cause the processor to request the TRP to transmit, in at least one of a multicast message or a broadcast message, the first indications to both the first user equipment and a second user equipment.

Clause 41. A user equipment comprising:

a transceiver;

a memory; and

a processor communicatively coupled to the transceiver and the memory and configured to:
transmit, via the transceiver to a network entity, an angle use capability message indicating a capability of the UE to use signal angle information to measure signals;
receive, via the transceiver from the network entity, a reference signal indication indicating a reference signal and at least one reference signal angle search window corresponding to the reference signal; and
search for the reference signal based on the at least one reference signal angle search window.

Clause 42. The user equipment of clause 41, wherein the processor is configured to report measurements of the reference signal only if the reference signal is received within the at least one reference signal angle search window.

Clause 43. The user equipment of clause 41, wherein the processor is configured to report measurements of the reference signal regardless of whether the reference signal is received outside the at least one reference signal angle search window.

Clause 44. The user equipment of clause 41, wherein the processor configured to transmit, via the transceiver to the network entity, an error message indicating that the user equipment failed to receive the reference signal within the at least one reference signal angle search window.

Clause 45. The user equipment of clause 44, wherein the processor is configured to include in the error message an actual angle of arrival of the reference signal.

Clause 46. The user equipment of clause 41, wherein the angle use capability message indicates at least one of:

a frequency band for which the capability of the user equipment to use the signal angle information to measure signals is applicable; or

a frequency band combination for which the capability of the user equipment to use the signal angle information to measure signals is applicable.

Clause 47. The user equipment of clause 41, wherein the processor is configured to determine whether a validity time of the reference signal indication has expired, and to search for the reference signal based on the at least one reference signal angle search window based on lack of expiration of the validity time of the reference signal indication.

Clause 48. A user equipment comprising:

means for transmitting, to a network entity, an angle use capability message indicating a capability of the user equipment to use signal angle information to measure signals;

means for receiving, from the network entity, a reference signal indication indicating a reference signal and at least one reference signal angle search window corresponding to the reference signal;

means for searching for the reference signal based on the at least one reference signal angle search window; and

means for measuring the reference signal.

Clause 49. The user equipment of clause 48, further comprising means for reporting measurements of the reference signal only if the reference signal is received within the at least one reference signal angle search window.

Clause 50. The user equipment of clause 48, further comprising means for reporting measurements of the reference signal regardless of whether the reference signal is received outside the at least one reference signal angle search window.

Clause 51. The user equipment of clause 48, further comprising means for transmitting, to the network entity, an error message indicating that the user equipment failed to receive the reference signal within the at least one reference signal angle search window.

Clause 52. The user equipment of clause 51, wherein the error message includes an actual angle of arrival of the reference signal.

Clause 53. The user equipment of clause 48, wherein the angle use capability message indicates at least one of:

a frequency band for which the capability of the user equipment to use the signal angle information to measure signals is applicable; or

a frequency band combination for which the capability of the user equipment to use the signal angle information to measure signals is applicable.

Clause 54. The user equipment of clause 48, further comprising means for determining whether a validity time of the reference signal indication has expired, wherein the means for searching comprise means for searching for the reference signal based on the at least one reference signal angle search window based on lack of expiration of the validity time of the reference signal indication.

Clause 55. A method for measuring a reference signal at a user equipment, the method comprising:

transmitting, from the user equipment to a network entity, an angle use capability message indicating a capability of the user equipment to use signal angle information to measure signals;

receiving, at the user equipment from the network entity, a reference signal indication indicating the reference signal and at least one reference signal angle search window corresponding to the reference signal;

searching, at the user equipment, for the reference signal based on the at least one reference signal angle search window; and

measuring the reference signal at the user equipment.

Clause 56. The method of clause 55, further comprising reporting measurements of the reference signal only if the reference signal is received within the at least one reference signal angle search window.

Clause 57. The method of clause 55, further comprising reporting measurements of the reference signal regardless of whether the reference signal is received outside the at least one reference signal angle search window.

Clause 58. The method of clause 55, further comprising transmitting, from the user equipment to the network entity, an error message indicating that the user equipment failed to receive the reference signal within the at least one reference signal angle search window.

Clause 59. The method of clause 58, wherein the error message includes an actual angle of arrival of the reference signal.

Clause 60. The method of clause 55, wherein the angle use capability message indicates at least one of:

a frequency band for which the capability of the user equipment to use the signal angle information to measure signals is applicable; or

a frequency band combination for which the capability of the user equipment to use the signal angle information to measure signals is applicable.

Clause 61. The method of clause 55, further comprising determining, at the user equipment, whether a validity time of the reference signal indication has expired, wherein searching for the reference signal based on the at least one reference signal angle search window is performed based on lack of expiration of the validity time of the reference signal indication.

Clause 62. A non-transitory, processor-readable storage medium comprising processor-readable instructions configured to cause a processor of a user equipment, in order to measure a reference signal, to:

transmit, to a network entity, an angle use capability message indicating a capability of the user equipment to use signal angle information to measure signals;

receive, from the network entity, a reference signal indication indicating the reference signal and at least one reference signal angle search window corresponding to the reference signal;

search, at the user equipment, for the reference signal based on the at least one reference signal angle search window; and

measure the reference signal at the user equipment.

Clause 63. The storage medium of clause 62, wherein the storage medium further comprises processor-readable instructions configured to cause the processor to report measurements of the reference signal only if the reference signal is received within the at least one reference signal angle search window.

Clause 64. The storage medium of clause 62, wherein the storage medium further comprises processor-readable instructions configured to cause the processor to report measurements of the reference signal regardless of whether the reference signal is received outside the at least one reference signal angle search window.

Clause 65. The storage medium of clause 62, wherein the storage medium further comprises processor-readable instructions configured to cause the processor to transmit, to the network entity, an error message indicating that the user equipment failed to receive the reference signal within the at least one reference signal angle search window.

Clause 66. The storage medium of clause 65, wherein the error message includes an actual angle of arrival of the reference signal.

Clause 67. The storage medium of clause 62, wherein the angle use capability message indicates at least one of:

a frequency band for which the capability of the user equipment to use the signal angle information to measure signals is applicable; or

a frequency band combination for which the capability of the user equipment to use the signal angle information to measure signals is applicable.

Clause 68. The storage medium of clause 62, wherein the storage medium further comprises processor-readable instructions configured to cause the processor to determine whether a validity time of the reference signal indication has expired, wherein the processor-readable instructions configured to cause the processor to search for the reference signal comprise processor-readable instructions configured to cause the processor to search for the reference signal based on the at least one reference signal angle search window based on lack of expiration of the validity time of the reference signal indication.

### OTHER CONSIDERATIONS

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, “or” as used in a list of items (possibly prefaced by “at least one of” or prefaced by “one or more of”) indicates a disjunctive list such that, for example, a list of “at least one of A, B, or C,” or a list of “one or more of A, B, or C” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection. A wireless communication network may not have all communications transmitted wirelessly, but is configured to have at least some communications transmitted wirelessly. Further, the term “wireless communication device,” or similar term, does not require that the functionality of the device is exclusively, or evenly primarily, for communication, or that the device be a mobile device, but indicates that the device includes wireless communication capability (one-way or two-way), e.g., includes at least one radio (each radio being part of a transmitter, receiver, or transceiver) for wireless communication.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the invention. Also, a number of operations may be undertaken before, during, or after the above elements are considered. Accordingly, the above description does not bound the scope of the claims.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

1. A network entity comprising:
an interface;
a memory; and
a processor communicatively coupled to the interface and the memory and configured to:
obtain reference signal angle information comprising first indications indicating a first reference signal and a first expected angle of arrival of the first reference signal; and
at least one of:
request a transmission/reception point (TRP) to transmit, to a user equipment, the first indications; or
request the TRP to search for the first reference signal based on the first expected angle of arrival.

2. The network entity of claim 1, wherein the processor is configured to at least one of: request the TRP to transmit, to the user equipment, a validity time indication associated with the first indications; or provide the validity time indication to the TRP.

3. The network entity of claim 2, wherein the processor is configured to determine a value of the validity time indication based on motion of the user equipment relative to the TRP.

4. The network entity of claim 1, wherein the first indications further indicate a first location, and wherein the reference signal angle information further comprises second indications indicating the first reference signal, a second expected angle of arrival of the first reference signal, and a second location, and wherein the processor is configured to:
obtain a user-equipment location of the user equipment; and
select the first indications from the reference signal angle information based on the user-equipment location corresponding to the first location.

5. The network entity of claim 4, wherein the processor is configured to request the TRP to transmit, to the user equipment, the first indications as one of a MAC-layer message or a physical-layer message.

6. The network entity of claim 1, wherein the first indications indicate the first expected angle of arrival of the first reference signal as a first angle search window including the first expected angle of arrival of the first reference signal.

7. The network entity of claim 6, wherein the reference signal angle information further comprises second indications indicating the first reference signal and a second expected angle of arrival of the first reference signal, wherein the first expected angle of arrival is different from the second expected angle of arrival, and wherein at least one of the first expected angle of arrival and the second expected angle of arrival corresponds to a non-line-of-sight path between the TRP and the user equipment.

8. The network entity of claim 1, wherein the processor is configured to analyze reference signal measurements and locations corresponding to the reference signal measurements in order to obtain the reference signal angle information.

9. The network entity of claim 1, wherein the processor is configured to request the TRP to transmit the first indications to the user equipment, and wherein the processor is configured to request the TRP to transmit the first indications to the user equipment in response to receiving, from the user equipment, a capability message indicating that the user equipment is configured to use angle-of-arrival information to measure reference signals.

10. The network entity of claim 1, wherein the user equipment is a first user equipment, and wherein the processor is configured to request the TRP to transmit, in at least one of a multicast message or a broadcast message, the first indications to both the first user equipment and a second user equipment.

11. A signal measurement assistance method comprising:
obtaining reference signal angle information comprising first indications indicating a first reference signal and a first expected angle of arrival of the first reference signal; and
at least one of:
requesting a transmission/reception point (TRP) to transmit, to a user equipment, the first indications; or
requesting the TRP to search for the first reference signal based on the first expected angle of arrival.

12. The signal measurement assistance method of claim 11, further comprising at least one of: requesting the TRP to transmit, to the user equipment, a validity time indication associated with the first indications; or providing the validity time indication to the TRP.

13. The signal measurement assistance method of claim 12, further comprising determining a value of the validity time indication based on motion of the user equipment relative to the TRP.

14. The signal measurement assistance method of claim 11, wherein the first indications further indicate a first location, and wherein the reference signal angle information further comprises second indications indicating the first reference signal, a second expected angle of arrival of the first reference signal, and a second location, the signal measurement assistance method further comprising:
obtaining a user-equipment location of the user equipment; and
selecting the first indications from the reference signal angle information based on the user-equipment location corresponding to the first location.

15. The signal measurement assistance method of claim 14, wherein the signal measurement assistance method comprises requesting the TRP to transmit the first indications to the user equipment as one of a MAC-layer message or a physical-layer message.

16. The signal measurement assistance method of claim 11, wherein the first indications indicate the first expected angle of arrival of the first reference signal as a first angle search window including the first expected angle of arrival of the first reference signal.

17. The signal measurement assistance method of claim 16, wherein the reference signal angle information further comprises second indications indicating the first reference signal and a second expected angle of arrival of the first reference signal, wherein the first expected angle of arrival is different from the second expected angle of arrival, and wherein at least one of the first expected angle of arrival and the second expected angle of arrival corresponds to a non-line-of-sight path between the TRP and the user equipment.

18. The signal measurement assistance method of claim 11, wherein obtaining the reference signal angle information comprises analyzing reference signal measurements and locations corresponding to the reference signal measurements.

19. The signal measurement assistance method of claim 11, wherein the signal measurement assistance method comprises requesting the TRP to transmit the first indications to the user equipment in response to receiving, from the user equipment, a capability message indicating that the user equipment is configured to use angle-of-arrival information to measure reference signals.

20. The signal measurement assistance method of claim 11, wherein the user equipment is a first user equipment, and wherein the signal measurement assistance method comprises requesting the TRP to transmit, in at least one of a multicast message or a broadcast message, the first indications to both the first user equipment and a second user equipment.

21. A user equipment comprising:
a transceiver;
a memory; and
a processor communicatively coupled to the transceiver and the memory and configured to:
transmit, via the transceiver to a network entity, an angle use capability message indicating a capability of the UE to use signal angle information to measure signals;
receive, via the transceiver from the network entity, a reference signal indication indicating a reference signal and at least one reference signal angle search window corresponding to the reference signal; and
search for the reference signal based on the at least one reference signal angle search window.

22. The user equipment of claim 21, wherein the processor is configured to report measurements of the reference signal only if the reference signal is received within the at least one reference signal angle search window.

23. The user equipment of claim 21, wherein the processor is configured to report measurements of the reference signal regardless of whether the reference signal is received outside the at least one reference signal angle search window.

24. The user equipment of claim 21, wherein the processor configured to transmit, via the transceiver to the network entity, an error message indicating that the user equipment failed to receive the reference signal within the at least one reference signal angle search window.

25. The user equipment of claim 24, wherein the processor is configured to include in the error message an actual angle of arrival of the reference signal.

26. The user equipment of claim 21, wherein the angle use capability message indicates at least one of:
a frequency band for which the capability of the user equipment to use the signal angle information to measure signals is applicable; or
a frequency band combination for which the capability of the user equipment to use the signal angle information to measure signals is applicable.

27. The user equipment of claim 21, wherein the processor is configured to determine whether a validity time of the reference signal indication has expired, and to search for the reference signal based on the at least one reference signal angle search window based on lack of expiration of the validity time of the reference signal indication.

28. A method for measuring a reference signal at a user equipment, the method comprising:
transmitting, from the user equipment to a network entity, an angle use capability message indicating a capability of the user equipment to use signal angle information to measure signals;
receiving, at the user equipment from the network entity, a reference signal indication indicating the reference signal and at least one reference signal angle search window corresponding to the reference signal;
searching, at the user equipment, for the reference signal based on the at least one reference signal angle search window; and
measuring the reference signal at the user equipment.

29. The method of claim 28, further comprising reporting measurements of the reference signal only if the reference signal is received within the at least one reference signal angle search window.

30. The method of claim 28, further comprising reporting measurements of the reference signal regardless of whether the reference signal is received outside the at least one reference signal angle search window.
